(19) United States
(12) Patent Application Publication
(10) Pub. No.: US 2022/0338422 A1
(43) Pub. Date: Oct. 27, 2022

(54) GROW TOWER DRIVE MECHANISM FOR AGRICULTURE PRODUCTION SYSTEMS

(71) Applicant: MJNN LLC, South San Francisco, CA (US)

(72) Inventors: Luke Asperger, Woodside, CA (US); Merritt Jonathan Jenkins, Emerylle, CA (US); Michael Peter Flynn, Palo Alto, CA (US); Anna Olson, San Mateo, CA (US); Kellen Murray, Belmont, CA (US); Andrew Dubel, Pacifica, CA (US); Matthew James Matera, San Francisco, CA (US); Charles Dylan Karr, San Francisco, CA (US); Mark Cuson, Los Altos, CA (US)

(73) Assignee: MJNN LLC, South San Francisco, CA (US)

(21) Appl. No.: 17/753,701

(22) PCT Filed: Jan. 30, 2020
(86) PCT No.: PCT/US20/15921

§ 371 Date: Mar. 11, 2022

Related U.S. Application Data
(60) Provisional application No. 62/903,712, filed on Sep. 20, 2019.

(51) Int. Cl. A01G 9/02; G05B 15/02

(52) U.S. Cl. CPC A01G 9/022; G05B 15/02

(57) ABSTRACT

A drive unit in a controlled agricultural environment increases a distance between an alignment element and a drive element in order to receive a plant support structure that is oriented non-vertically so that the plant support structure rests on the drive element or the alignment element. The drive unit decreases the distance between the alignment element and the drive element so that the alignment element or the drive element rests on the plant support structure. The drive element conveys the plant support structure along a direction of conveyance.

### CROSS-REFERENCE TO RELATED APPLICATIONS

This application claims the benefit of priority of U.S. Provisional Application No. 62/903,712, filed Sep. 20, 2019, assigned to the assignee of the present disclosure, and incorporated by reference in its entirety herein.

### BACKGROUND

### Field of the Disclosure

The disclosure relates generally to controlled environment agriculture and, more particularly, to conveying elongated plant support structures, such as grow towers, in a controlled agricultural environment.

### Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

During the twentieth century, agriculture slowly began to evolve from a conservative industry to a fast-moving high-tech industry in order to keep up with world food shortages, climate change, and societal changes. Farming began to move away from manually-implemented agricultural techniques toward computer-implemented technologies. Conventionally, farmers only have one growing season to produce the crops that would determine their revenue and food production for the entire year. However, this is changing. With indoor growing as an option, and with better access to data processing technologies and other advanced techniques, the science of agriculture has become more agile. It is adapting and learning as new data is collected and insights are generated.

Advancements in technology are making it feasible to control the effects of nature with the advent of “controlled indoor agriculture,” otherwise known as “controlled environment agriculture.” Improved efficiencies in space utilization and lighting, a better understanding of hydroponics, aeroponics, and crop cycles, and advancements in environmental control systems have allowed humans to better recreate environments conducive for agriculture crop growth with the goals of greater harvest weight yield per square foot, better nutrition and lower cost.

US Patent Publication Nos. 2018/0014485 and 2018/0014486, both assigned to the assignee of the present disclosure and incorporated by reference in their entirety herein, describe environmentally controlled vertical farming systems. The vertical farming structure (e.g., a vertical column) may be moved about an automated conveyance system in an open or closed-loop fashion, exposed to precision-controlled lighting, airflow and humidity, with ideal nutritional support.

### SUMMARY OF THE DISCLOSURE

Embodiments of the disclosure provide methods, systems, and computer-readable media storing instructions for operating one or more drive units in a controlled agricultural environment. For each of the one or more drive units, embodiments of the disclosure increase a distance between an alignment element and a drive element, receive a plant support structure that is oriented non-vertically so that the plant support structure rests on the drive element or the alignment element of each of the one or more drive units, and decrease the distance between the alignment element and the drive element so that the alignment element or the drive element rests on the plant support structure. For each of the one or more drive units, embodiments of the disclosure drive the drive element to convey the plant support structure.

Embodiments of the disclosure decrease the distance in response to sensing the presence of the plant support structure in the drive unit. Embodiments of the disclosure apply a force via the alignment element or the drive element to force the plant support structure against the drive element or the alignment element, respectively.

According to embodiments of the disclosure, the plant support structure comprises a grow tower. According to embodiments of the disclosure, the plant support structure includes a groove that rests on the drive element or the alignment element. According to embodiments of the disclosure, the alignment element comprises one or more rollers, one or more wheels, a linear bearing element, a belt, a tread, one or more gears, or a fixed material that has a coefficient of friction against the plant support structure less than a coefficient of friction of the drive element against the plant support structure; and the drive element comprises one or more rollers, one or more wheels, a belt, a tread, a linear actuator, or one or more gears.

Embodiments of the disclosure generate a slippage detection signal based at least in part upon a comparison of a measured position or motion of the plant support structure with a desired position or motion of the plant support structure. Embodiments of the disclosure trigger an action based upon detection of slippage.

According to embodiments of the disclosure, A drive unit in a controlled agricultural environment comprises: an alignment element; a drive element; and an actuator for adjusting a distance between the alignment element and the drive element. The actuator may increase the distance to enable reception of a plant support structure, and to decrease the distance to cause the alignment element and the drive element to contact opposing sides of the plant support structure. The drive unit may comprise a second actuator to drive the drive element to convey the plant support structure. The actuator may decrease the distance in response to one or more sensors sensing the presence of the plant support structure in the drive unit.

The drive unit may comprise a grow tower, and may include a groove that rests on the drive element or the alignment element.

The actuator may apply a force via the alignment element or the drive element to force the plant support structure against the drive element or the alignment element, respectively.

According to embodiments of the disclosure, the drive unit may include: one or more sensors; one or more memories storing instructions; and one or more processors, coupled to the one or more memories, that execute the instructions to cause performance of: commanding the drive element to achieve a desired position or motion of the plant support structure; determining a measured position or motion of the plant support structure, wherein the measured position or motion is based at least in part upon a signal from the one or more sensors; and generating a slippage detection signal based at least in part upon comparing the measured position or motion with the desired position or motion.

Further embodiments are summarized in the section below entitled “Selected Embodiments of the Disclosure.”

### BRIEF DESCRIPTION OF THE DRAWINGS

FIG. 1 is a functional block diagram illustrating an example controlled environment agriculture system.

FIG. 2 is a perspective view of an example controlled environment agriculture system.

FIGS. 3A and 3B are perspective views of an example grow tower.

FIG. 4A is a top, end view of an example grow tower; FIG. 4B is a perspective, top view of an example grow tower; FIG. 4C is an elevation view of a section of an example grow tower; and FIG. 4D is a side cross-sectional, elevation view of a portion of an example grow tower having receptacles for supporting plants.

FIG. 5A is a perspective view of a portion of an example grow line.

FIG. 5B is a perspective view of an example tower hook.

FIG. 6 is an exploded, perspective view of a portion of an example grow line and reciprocating cam mechanism.

FIG. 7A is a sequence diagram illustrating operation of an example reciprocating cam mechanism.

FIG. 7B illustrates an alternative cam channel including an expansion joint.

FIG. 8 is a profile view of an example grow line and irrigation supply line.

FIG. 9 is a side view of an example tower hook and integrated funnel structure.

FIG. 10 is a profile view of an example grow line.

FIG. 11A is perspective view of an example tower hook and integrated funnel structure;

FIG. 11B is a section view of an example tower hook and integrated funnel structure; and

FIG. 11C is a top view of an example tower hook and integrated funnel structure.

FIG. 12 is an elevation view of an example carriage assembly.

FIG. 13A is an elevation view of the example carriage assembly from an alternative angle to FIG. 12; and FIG. 13B is a perspective view of the example carriage assembly.

FIG. 14 is a partial perspective view of an example automated laydown station.

FIG. 15A is a partial perspective view of an example automated pickup station; and,

FIG. 15B is an alternative partial perspective view of the example automated pickup station.

FIG. 16 is a perspective view of an example end effector for use in an automated pickup or laydown station.

FIGS. 17A and 17B are partial, perspective views of an example gripper assembly mounted to an end effector for releasably grasping grow towers.

FIG. 18 is a partial perspective view of the example automated pickup station.

FIG. 19A is partial perspective view of the example automated pickup station that illustrates an example constraining mechanism that facilitates location of grow towers; FIG. 19B is a perspective view of a second example lead-in feature that facilitates location of grow towers for laydown operations; FIGS. 19C and 19D are alternative views illustrating how the example lead-in feature operates in connection with an end effector of a laydown station.

FIG. 20 is a side view of an example inbound harvester conveyor.

FIG. 21 is a functional block diagram of the stations and conveyance mechanisms of an example central processing system.

FIG. 22 is a partial perspective view of an example pickup conveyor.

FIG. 23A is a perspective view of an example harvester station; FIG. 23B is a side elevation view of an example harvester machine; FIG. 23C is an enlarged side elevation view of an example harvester machine; FIG. 23D is a perspective view of an example harvester machine; FIG. 23E is a sectional view of an example harvester machine; and FIG. 23F is a perspective view of an example internal grouping member.

FIG. 24A is an elevation view of an example end effector for use in a transplanter station.

FIG. 24B is a perspective view of a transplanter station.

FIG. 25 illustrates an example of a computer system that may be used to execute instructions stored in a non-transitory computer readable medium (e.g., memory) in accordance with embodiments of the disclosure.

FIG. 26 is an exemplary schematic of a grow tower drive mechanism and grow tower position sensors.

FIGS. 27A and 27B illustrate perspective views and FIG. 27 C illustrates a side view of a tower drive unit according to embodiments of the disclosure. FIG. 27C is a side view of the tower drive unit of FIG. 27A holding a grow tower. FIG. 27D is a perspective view illustrating an alternative embodiment of a tower drive unit including limit stops.

FIG. 28 illustrates a tower conveyed by the drive units through multiple tower cleaning modules of a washing station.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

The present disclosure provides harvesting systems and subsystems that operate on plant support structures, such as grow towers. According to embodiments of the disclosure, these systems and subsystems may be configured for use in automated crop production systems for controlled environment agriculture. The present invention, however, is not limited to any particular crop production environment, which may be an automated controlled grow environment, an outdoor environment or any other suitable crop production environment.

The following describes examples of a vertical farm production system configured for high density growth and crop yield.

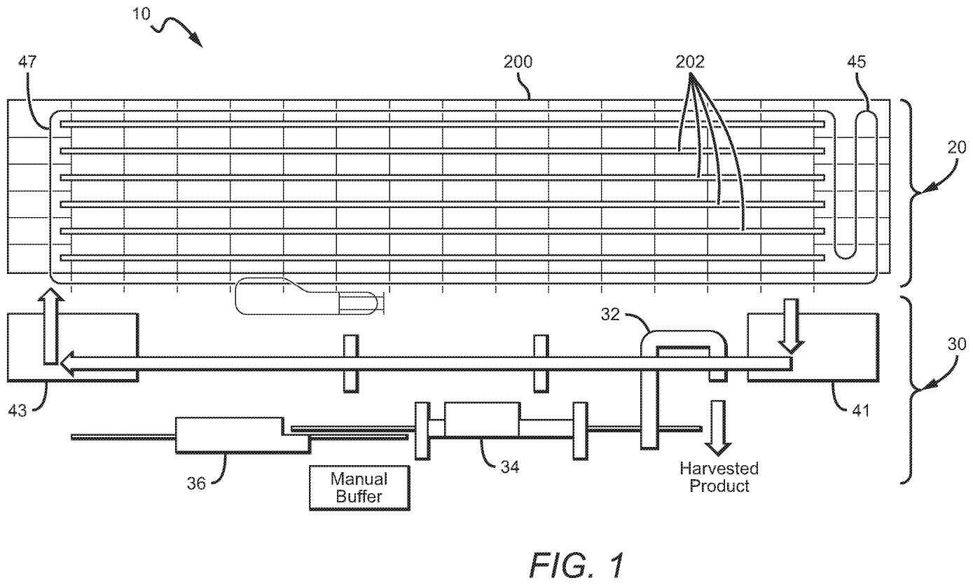

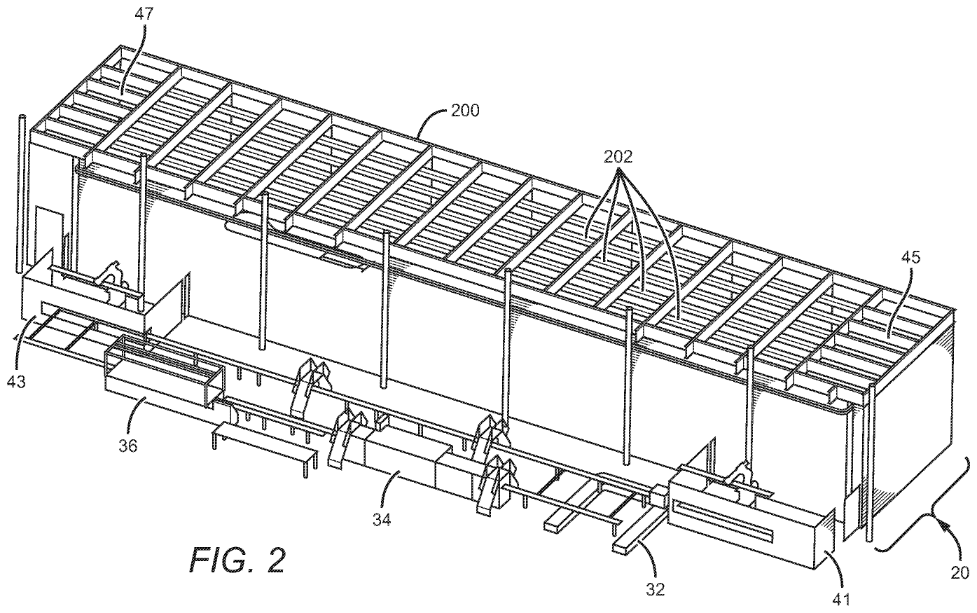

FIGS. 1 and 2 illustrate a controlled environment agriculture system 10, according to embodiments of the disclosure. At a high level, the system 10 may include an environmentally-controlled growing chamber 20, a vertical tower conveyance system 200 that is disposed within the growing chamber 20 and configured to convey vertical grow towers with crops disposed therein, and a central processing facility 30. The plant varieties that may be grown may be gravitropic/geotropic, phototropic, hydroponic, or some combination thereof. The varieties may vary considerably and include various leaf vegetables, fruiting vegetables, flowering crops, fruits, and the like. The controlled environment agriculture system 10 may be configured to grow a single crop type at a time or to grow multiple crop types concurrently.

The system 10 may also include conveyance systems for moving the grow towers in a circuit throughout the crop's growth cycle, the circuit comprising a staging area configured to load the grow towers into and out of the vertical tower conveyance mechanism 200. The central processing system 30 may include one or more conveyance mechanisms for directing grow towers to stations in the central processing system 30—e.g., stations for loading plants into, and harvesting crops from, the grow towers. The vertical tower conveyance system 200, within the growing chamber 20, is configured to support and translate one or more grow towers 50 along grow lines 202. According to embodiments of the disclosure, the grow towers 50 hang from the grow lines 202.

Each grow tower 50 is configured to contain plant growth media that supports a root structure of at least one crop plant growing therein. Each grow tower 50 is also configured to releasably attach to a grow line 202 in a vertical orientation and move along the grow line 202 during a growth phase. Together, the vertical tower conveyance mechanism 200 and the central processing system 30 (including associated conveyance mechanisms) can be arranged in a production circuit under control of one or more computing systems.

The growth environment 20 may include light emitting sources positioned at various locations between and along the grow lines 202 of the vertical tower conveyance system 200. The light emitting sources can be positioned laterally relative to the grow towers 50 in the grow line 202 and configured to emit light toward the lateral faces of the grow towers 50 that include openings from which crops grow. The light emitting sources may be incorporated into a water-cooled, LED lighting system as described in U.S. Publ. No. 2017/0146226A1, the disclosure of which is incorporated by reference herein. In such an embodiment, the LED lights may be arranged in a bar-like structure. The bar-like structure may be placed in a vertical orientation to emit light laterally to substantially the entire length of adjacent grow towers 50. Multiple light bar structures may be arranged in the growth environment 20 along and between the grow lines 202. Other lighting systems and configurations may be employed. For example, the light bars may be arranged horizontally between grow lines 202.

The growth environment 20 may also include a nutrient supply system configured to supply an aqueous crop nutrient solution to the crops as they translate through the growth chamber 20. The nutrient supply system may apply aqueous crop nutrient solution to the top of the grow towers 50. Gravity may cause the solution travel down the vertically-oriented grow tower 50 and through the length thereof to supply solution to the crops disposed along the length of the grow tower 50. The growth environment 20 may also include an airflow source that is configured to, when a tower is mounted to a grow line 202, direct airflow in the lateral growth direction of growth and through an under-canopy of the growing plant, so as to disturb the boundary layer of the under-canopy of the growing plant. In other implementations, airflow may come from the top of the canopy or orthogonal to the direction of plant growth. The growth environment 20 may also include a control system, and associated sensors, for regulating at least one growing condition, such as air temperature, airflow speed, relative air humidity, and ambient carbon dioxide gas content. The control system may for example include such sub-systems as HVAC units, chillers, fans and associated ducting and air handling equipment. Grow towers 50 may have identifying attributes (such as bar codes or RFID tags). The controlled environment agriculture system 10 may include corresponding sensors and programming logic for tracking the grow towers 50 during various stages of the farm production cycle or for controlling one or more conditions of the growth environment. The operation of control system and the length of time towers remain in the growth environment can vary considerably depending on a variety of factors, such as crop type and other factors.

As discussed above, grow towers 50 with newly transplanted crops or seedlings are transferred from the central processing system 30 into the vertical tower conveyance system 200. Vertical tower conveyance system 200 moves the grow towers 50 along respective grow lines 202 in growth environment 20 in a controlled fashion. Crops disposed in grow towers 50 are exposed to the controlled conditions of the growth environment (e.g., light, temperature, humidity, air flow, aqueous nutrient supply, etc.). The control system is capable of automated adjustments to optimize growing conditions within the growth chamber 20 to make continuous improvements to various attributes, such as crop yields, visual appeal and nutrient content. In addition, US Patent Publication Nos. 2018/0014485 and 2018/0014486, incorporated by reference herein, describe application of machine learning and other operations to optimize grow conditions in a vertical farming system. In some implementations, environmental condition sensors may be disposed on grow towers 50 or at various locations in the growth environment 20. When crops are ready for harvesting, grow towers 50 with crops to be harvested are transferred from the vertical tower conveyance system 200 to the central processing system 30 for harvesting and other processing operations.

Central processing system 30, as discussed in more detail below, may include processing stations directed to injecting seedlings into towers 50, harvesting crops from towers 50, and cleaning towers 50 that have been harvested. Central processing system 30 may also include conveyance mechanisms that move towers 50 between such processing stations. For example, as FIG. 1 illustrates, central processing system 30 may include harvester station 32, washing station 34, and transplanter station 36. Harvester station 32 may deposit harvested crops into food-safe containers and may include a conveyance mechanism for conveying the containers to post-harvesting facilities (e.g., preparation, washing, packaging and storage).

Controlled environment agriculture system 10 may also include one or more conveyance mechanisms for transferring grow towers 50 between growth environment 20 and central processing system 30. In the implementation shown, the stations of central processing system 30 operate on grow towers 50 in a horizontal orientation. In embodiments of the disclosure, an automated pickup (loading) station 43, and associated control logic, may be operative to releasably grasp a horizontal tower from a loading location, rotate the tower to a vertical orientation and attach the tower to a transfer station for insertion into a selected grow line 202 of the growth environment 20. On the other end of growth environment 20, automated laydown (unloading) station 41, and associated control logic, may be operative to releasably grasp and move a vertically-oriented grow tower 50 from a buffer location, rotate the grow tower 50 to a horizontal orientation and place it on a conveyance system (such as a tower drive unit 2700 described below) for loading into harvester station 32. In some implementations, if a grow tower 50 is rejected due to quality control concerns, the conveyance system may bypass the harvester station 32 and carry the grow tower to washing station 34 (or some other station). The automated laydown and pickup stations 41 and 43 may each comprise a six-degrees of freedom robotic arm 1502, such as a FANUC robot. The stations 41 and 43 may also include end effectors for releasably grasping grow towers 50 at opposing ends.

Growth environment 20 may also include automated loading and unloading mechanisms for inserting grow towers 50 into selected grow lines 202 and unloading grow towers 50 from the grow lines 202. In embodiments of the disclosure, the load transfer conveyance mechanism 47 may include a powered and free conveyor system that conveys carriages each loaded with a grow tower 50 from the automated pickup station 43 to a selected grow line 202. Vertical grow tower conveyance system 200 may include sensors (such as RFID or bar code sensors) to identify a given grow tower 50 and, under control logic, select a grow line 202 for the grow tower 50. Particular algorithms for grow line selection can vary considerably depending on a number of factors. The load transfer conveyance mechanism 47 may also include one or more linear actuators that pushes the grow tower 50 onto a grow line 202. Similarly, the unload transfer conveyance mechanism 45 may include one or more linear actuators that push or pull grow towers from a grow line 202 onto a carriage of another powered and free conveyor mechanism, which conveys the carriages 1202 from the grow line 202 to the automated laydown station 41.

FIG. 12 illustrates a carriage 1202 that may be used in a powered and free conveyor mechanism. In the implementation shown, carriage 1202 includes hook 1204 that engages hook 52 of grow tower 50. A latch assembly 1206 may secure the grow tower 50 while it is being conveyed to and from various locations in the system. In embodiments of the disclosure, one or both of load transfer conveyance mechanism 47 and unload transfer conveyance mechanism 45 may be configured with a sufficient track distance to establish a zone where grow towers 50 may be buffered. For example, unload transfer conveyance mechanism 45 may be controlled such that it unloads a set of towers 50 to be harvested unto carriages 1202 that are moved to a buffer region of the track. On the other end, automated pickup station 43 may load a set of towers to be inserted into growth environment 20 onto carriages 1202 disposed in a buffer region of the track associated with load transfer conveyance mechanism 47.

### Grow Towers

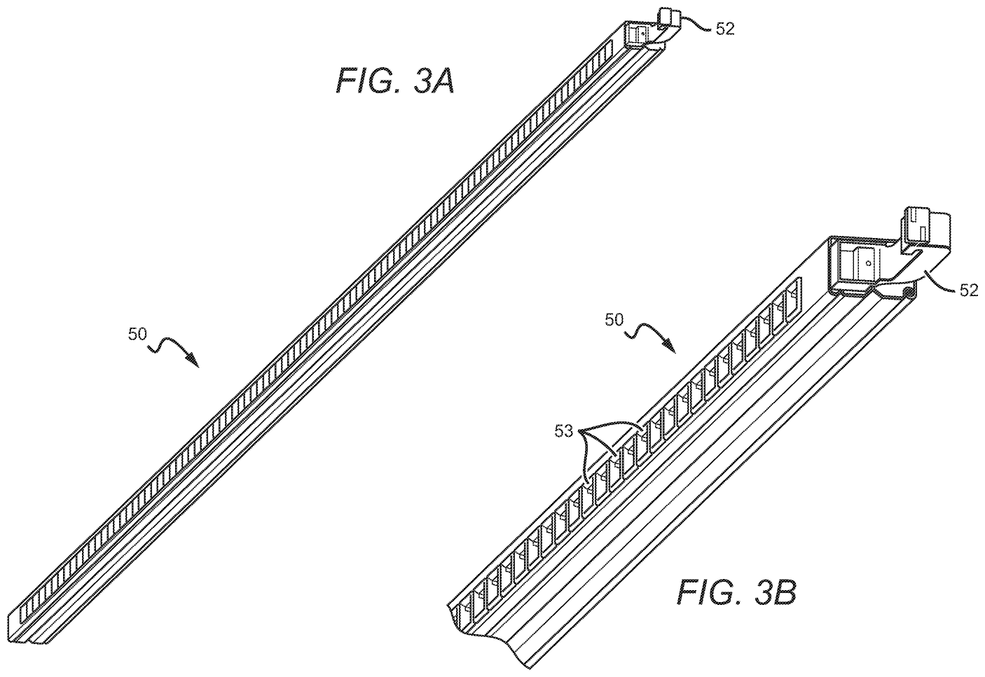

Grow towers 50 provide the sites for individual crops to grow in the system. As FIGS. 3A and 3B illustrate, a hook 52 attaches to the top of grow tower 50. Hook 52 allows grow tower 50 to be supported by a grow line 202 when it is inserted into the vertical tower conveyance system 200. In embodiments of the disclosure, a grow tower 50 measures 5.172 meters long, where the extruded length of the tower is 5.0 meters, and the hook is 0.172 meters long. The extruded rectangular profile of the grow tower 50, in embodiments of the disclosure, measures 57 mm×93 mm (2.25″×3.67″). The hook 52 can be designed such that its exterior overall dimensions are not greater than the extruded profile of the grow tower 50.

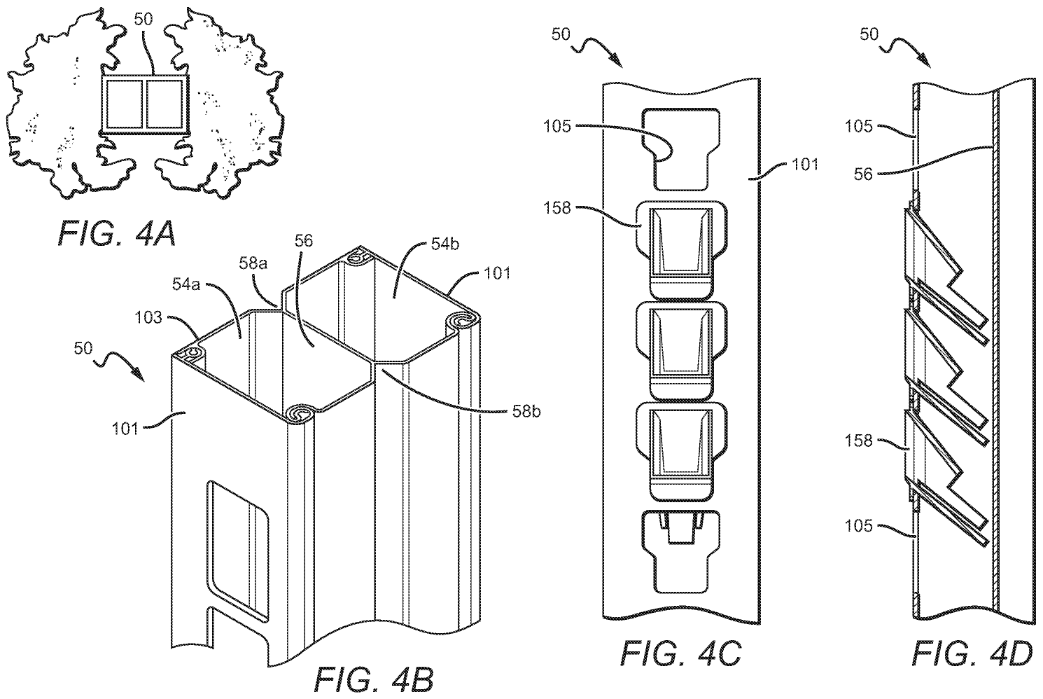

Grow towers 50 may include a set of grow sites 53 arrayed along at least one face of the grow tower 50. In the implementation shown in FIG. 4A, grow towers 50 include grow sites 53 on opposing faces such that plants protrude from opposing sides of the grow tower 50. Transplanter station 36 may transplant seedlings into empty grow sites 53 of grow towers 50, where they remain in place until they are fully mature and ready to be harvested. In embodiments of the disclosure, the orientation of the grow sites 53 are perpendicular to the direction of travel of the grow towers 50 along grow line 202. In other words, when a grow tower 50 is inserted into a grow line 202, plants extend from opposing faces of the grow tower 50, where the opposing faces are parallel to the direction of travel. Although a dual-sided configuration is preferred, embodiments of the disclosure may employ single-sided configuration where plants grow along a single face of a grow tower 50.

U.S. application Ser. No. 15/968,425 filed on May 1, 2018 which is incorporated by reference herein for all purposes, discloses an example tower structure configuration that can be used in connection with various embodiments of the invention. Grow towers 50 may each consist of three extrusions which snap together to form one structure. Grow towers 50 may be made of an extruded plastic, such as acrylonitrile butadiene styrene (ABS), polyvinyl chloride (PVC), polyethylene, polypropylene, and the like. As shown, the grow tower 50 may be a dual-sided hydroponic tower, where the tower body 103 includes a central wall 56 that defines a first tower cavity 54a and a second tower cavity 54b. FIG. 4B provides a perspective view of an exemplary dual-sided, multi-piece hydroponic grow tower 50 in which each front face plate 101 is hingeably coupled to the tower body 103. In FIG. 4B, each front face plate 101 is in the closed position. The cross-section of the tower cavities 54a, 54b may be in the range of 1.5 inches by 1.5 inches to 3 inches by 3 inches, where the term “tower cavity” refers to the region within the body of the tower and behind the tower face plate. The wall thickness of the grow towers 50 maybe within the range of 0.065 to 0.075 inches. A dual-sided hydroponic tower, such as that shown in FIGS. 4A and 4B, has two back-to-back cavities 54a and 54b, each preferably within the noted size range. In the configuration shown, the grow tower 50 may include (i) a first V-shaped groove 58a running along the length of a first side of the tower body 103, where the first V-shaped groove is centered between the first tower cavity and the second tower cavity; and (ii) a second V-shaped groove 58b running along the length of a second side of the tower body 103, where the second V-shaped groove is centered between the first tower cavity and the second tower cavity. The V-shaped grooves 58a, 58b may facilitate registration, alignment and/or feeding of the towers 50 by one or more of the stations in central processing system 30. U.S. application Ser. No. 15/968,425 discloses additional details regarding the construction and use of towers that may be used in embodiments of the invention. Another attribute of V-shaped grooves 58a, 58b is that they effectively narrow the central wall 56 to promote the flow of aqueous nutrient solution centrally where the plant's roots are located.

As FIGS. 4C and 4D illustrate, plant support structures, such as grow towers 50, may each include a plurality of receptacles 105, for example cut-outs 105 as shown, for use with a compatible growth module 158 such as a the plug holder disclosed in any one of co-assigned and co-pending U.S. patent application Ser. Nos. 15/910,308, 15/910,445 and 15/910,796, each filed on 2 Mar. 2018, the disclosures of which is incorporated herein for any and all purposes. As shown, the plug holders 158 may be oriented at a 45-degree angle relative to the front face plate 101 (insertion plane) and the vertical axis of the grow tower 50. It should be understood, however, that tower design disclosed in the present application is not limited to use with this particular plug holder or orientation; rather, the towers disclosed herein may be used with any suitably sized and/or oriented plug holder. For example, the plug holders 158 may be oriented at other angles (e.g., 10 to 80 degrees) relative to the front face plate 101 or insertion plane. As such, cut-outs 105 are only meant to illustrate, not limit, the present tower design and it should be understood that the present invention is equally applicable to towers with other cut-out designs. Plug Holder 158 may be ultrasonically welded, bonded, or otherwise attached to tower face 101.

The use of a hinged front face plate simplifies manufacturing of grow towers 50, as well as tower maintenance in general and tower cleaning in particular. For example, to clean a grow tower 50 the face plates 101 are unhinged (i.e., opened) from the body 103 to allow easy access to the body cavity 54a or 54b. After cleaning, the face plates 101 are closed. Since the face plates remain attached to the tower body 103 throughout the cleaning process, it is easier to maintain part alignment and to ensure that each face plate is properly associated with the appropriate tower body and, assuming a double-sided tower body, that each face plate 101 is properly associated with the appropriate side of a specific tower body 103. Additionally, if the planting and/or harvesting operations are performed with the face plate 101 in the open position, for the dual-sided configuration both face plates can be opened and simultaneously planted and/or harvested, thus eliminating the step of planting and/or harvesting one side and then rotating the tower and planting and/or harvesting the other side. In other embodiments, planting and/or harvesting operations are performed with the face plate 101 in the closed position.

Other implementations are possible. For example, grow tower 50 can comprise any tower body that includes a volume of medium or wicking medium extending into the tower interior from the face of the tower (either a portion or individual portions of the tower or the entirety of the tower length. For example, U.S. Pat. No. 8,327,582, which is incorporated by reference herein, discloses a grow tube having a slot extending from a face of the tube and a grow medium contained in the tube. The tube illustrated therein may be modified to include a hook 52 at the top thereof and to have slots on opposing faces, or one slot on a single face.

### Vertical Tower Conveyance System

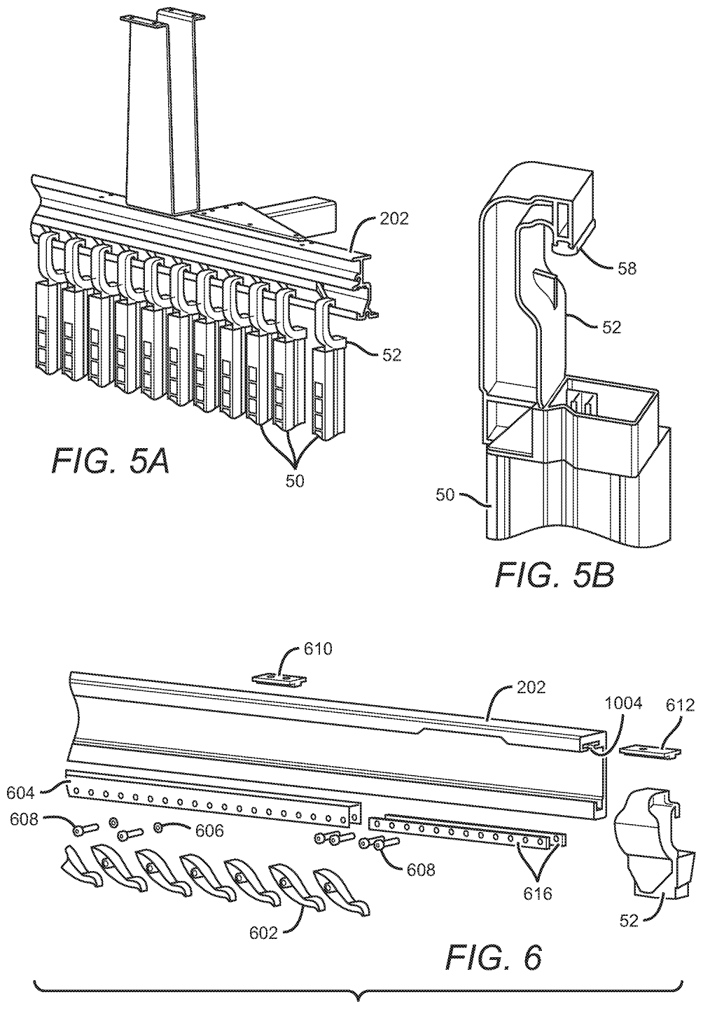

FIG. 5A illustrates a portion of a grow line 202 in vertical tower conveyance system 200. In embodiments of the disclosure, the vertical tower conveyance system 200 includes a plurality of grow lines 202 arranged in parallel. As discussed elsewhere herein, automated loading and unloading mechanisms 45, 47 may selectively load and unload grow towers 50 from a grow line 202 under automated control systems. As FIG. 5A shows, each grow line 202 supports a plurality of grow towers 50. In embodiments of the disclosure, a grow line 202 may be mounted to the ceiling (or other support) of the grow structure by a bracket for support purposes. Hook 52 hooks into, and attaches, a grow tower 50 to a grow line 202, thereby supporting the tower in a vertical orientation as it is translated through the vertical tower conveyance system 200. A conveyance mechanism moves towers 50 attached to respective grow lines 202.

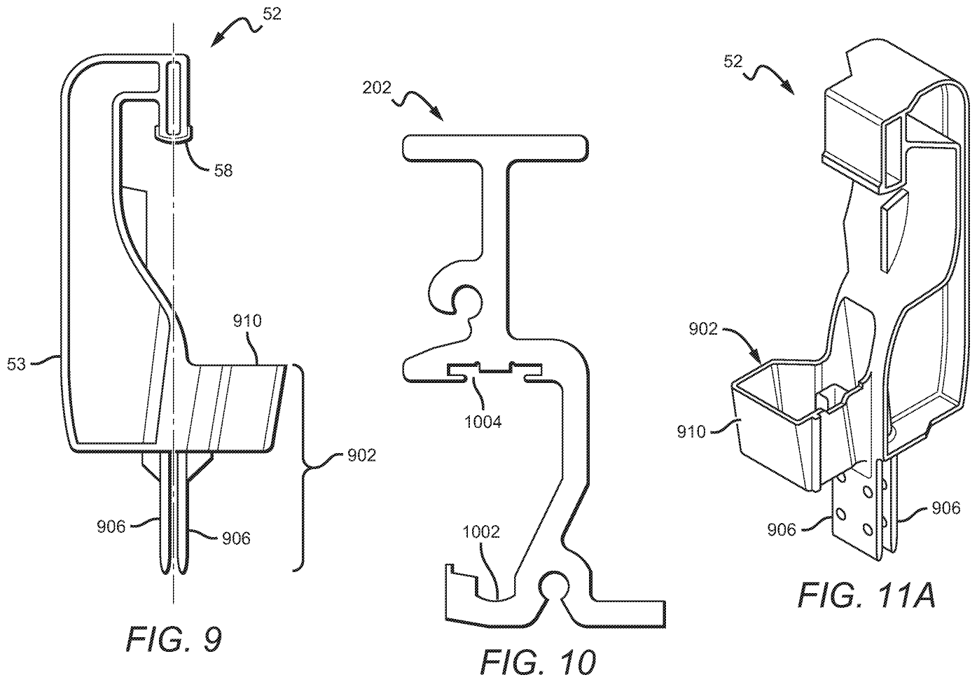

FIG. 10 illustrates the cross section or extrusion profile of a grow line 202, according to embodiments of the disclosure. The grow line 202 may be an aluminum extrusion. The bottom section of the extrusion profile of the grow line 202 includes an upward facing groove 1002. As FIG. 9 shows, hook 52 of a grow tower 50 includes a main body 53 and corresponding member 58 that engages groove 1002 as shown in FIGS. 5A and 8. These hooks allow the grow towers 50 to hook into the groove 1002 and slide along the grow line 202 as discussed below. Conversely, grow towers 50 can be manually unhooked from a grow line 202 and removed from production. This ability may be necessary if a crop in a grow tower 50 becomes diseased so that it does not infect other towers. In one possible implementation, the width of groove 1002 (for example, 13 mm) is an optimization between two different factors. First, the narrower the groove the more favorable the binding rate and the less likely grow tower hooks 52 are to bind. Conversely, the wider the groove the slower the grow tower hooks wear due to having a greater contact patch. Similarly, the depth of the groove, for example 10 mm, may be an optimization between space savings and accidental fallout of tower hooks.

Hooks 52 may be injection-molded plastic parts. In embodiments of the disclosure, the plastic may be polyvinyl chloride (PVC), acrylonitrile butadiene styrene (ABS), or an Acetyl Homopolymer (e.g., Delrin® sold by DuPont Company). The hook 52 may be solvent bonded to the top of the grow tower 50 and/or attached using rivets or other mechanical fasteners. The groove-engaging member 58 which rides in the rectangular groove 1002 of the grow line 202 may be a separate part or integrally formed with hook 52. If separate, this part can be made from a different material with lower friction and better wear properties than the rest of the hook, such as ultra-high-molecular weight polyethylene or acetal. To keep assembly costs low, this separate part may snap onto the main body of the hook 52. Alternatively, the separate part also be over-molded onto the main body of hook 52.

As FIGS. 6 and 10 illustrate, the top section of the extrusion profile of grow line 202 contains a downward facing t-slot 1004. Linear guide carriages 610 (described below) ride within the t-slot 1004. The center portion of the t-slot 1004 may be recessed to provide clearance from screws or over-molded inserts which may protrude from the carriages 610. Each grow line 202 can be assembled from a number of separately fabricated sections. In embodiments of the disclosure, sections of grow line 202 are currently modeled in 6-meter lengths. Longer sections reduce the number of junctions but are more susceptible to thermal expansion issues and may significantly increase shipping costs. Additional features not captured by the Figures include intermittent mounting holes to attach the grow line 202 to the ceiling structure and to attach irrigation lines. Interruptions to the t-slot 1004 may also be machined into the conveyor body. These interruptions allow the linear guide carriages 610 to be removed without having to slide them all the way out the end of a grow line 202.

At the junction between two sections of a grow line 202, a block 612 may be located in the t-slots 1004 of both conveyor bodies. This block serves to align the two grow line sections so that grow towers 50 may slide smoothly between them. Alternative methods for aligning sections of a grow line 202 include the use of dowel pins that fit into dowel holes in the extrusion profile of the section. The block 612 may be clamped to one of the grow line sections via a set screw, so that the grow line sections can still come together and move apart as the result of thermal expansion. Based on the relatively tight tolerances and small amount of material required, these blocks may be machined. Bronze may be used as the material for such blocks due to its strength, corrosion resistance, and wear properties.

In embodiments of the disclosure, the vertical tower conveyance system 200 utilizes a reciprocating linear ratchet and pawl structure (hereinafter referred to as a “reciprocating cam structure or mechanism”) to move grow towers 50 along a grow line 202. FIGS. 5A, 6 and 7 illustrate a reciprocating cam mechanism that can be used to move grow towers 50 across grow lines 202. Pawls or “cams” 602 physically push grow towers 50 along grow line 202. Cams 602 are attached to cam channel 604 (see below) and rotate about one axis. On the forward stroke, the rotation is limited by the top of the cam channel 604, causing the cams 602 to push grow towers 50 forward. On the reserve or back stroke, the rotation is unconstrained, thereby allowing the cams to ratchet over the top of the grow towers 50. In this way, the cam mechanism can stroke a relatively short distance back and forth, yet grow towers 50 always progress forward along the entire length of a grow line 202. A control system, in embodiments of the disclosure, controls the operation of the reciprocating cam mechanism of each grow line 202 to move the grow towers 50 according to a programmed growing sequence. In between movement cycles, the actuator and reciprocating cam mechanism remain idle.

The pivot point of the cams 602 and the means of attachment to the cam channel 604 consists of a binding post 606 and a hex head bolt 608; alternatively, detent clevis pins may be used. The hex head bolt 608 is positioned on the inner side of the cam channel 604 where there is no tool access in the axial direction. Being a hex head, it can be accessed radially with a wrench for removal. Given the large number of cams needed for a full-scale farm, a high-volume manufacturing process such as injection molding is suitable. ABS is suitable material given its stiffness and relatively low cost. All the cams 602 for a corresponding grow line 202 are attached to the cam channel 604. When connected to an actuator, this common beam structure allows all cams 602 to stroke back and forth in unison. The structure of the cam channel 604, in embodiments of the disclosure, is a downward facing u-channel constructed from sheet metal. Holes in the downward facing walls of cam channel 604 provide mounting points for cams 602 using binding posts 606.

Holes of the cam channel 604, in embodiments of the disclosure, are spaced at 12.7 mm intervals. Therefore, cams 602 can be spaced relative to one another at any integer multiple of 12.7 mm, allowing for variable grow tower spacing with only one cam channel. The base of the cam channel 604 limits rotation of the cams during the forward stroke. All degrees of freedom of the cam channel 604, except for translation in the axial direction, are constrained by linear guide carriages 610 (described below) which mount to the base of the cam channel 604 and ride in the t-slot 1004 of the grow line 202. Cam channel 604 may be assembled from separately formed sections, such as sections in 6-meter lengths. Longer sections reduce the number of junctions but may significantly increase shipping costs. Thermal expansion is generally not a concern because the cam channel is only fixed at the end connected to the actuator. Given the simple profile, thin wall thickness, and long length needed, sheet metal rolling is a suitable manufacturing process for the cam channel. Galvanized steel is a suitable material for this application.

Linear guide carriages 610 are bolted to the base of the cam channels 604 and ride within the t-slots 1004 of the grow lines 202. In some implementations, one carriage 610 is used per 6-meter section of cam channel. Carriages 610 may be injection molded plastic for low friction and wear resistance. Bolts attach the carriages 610 to the cam channel 604 by threading into over molded threaded inserts. If select cams 602 are removed, these bolts are accessible so that a section of cam channel 604 can be detached from the carriage and removed.

Sections of cam channel 604 are joined together with pairs of connectors 616 at each joint; alternatively, detent clevis pins may be used. Connectors 616 may be galvanized steel bars with machined holes at 20 mm spacing (the same hole spacing as the cam channel 604). Shoulder bolts 618 pass through holes in the outer connector, through the cam channel 604, and thread into holes in the inner connector. If the shoulder bolts fall in the same position as a cam 602, they can be used in place of a binding post. The heads of the shoulder bolts 618 are accessible so that connectors and sections of cam channel can be removed.

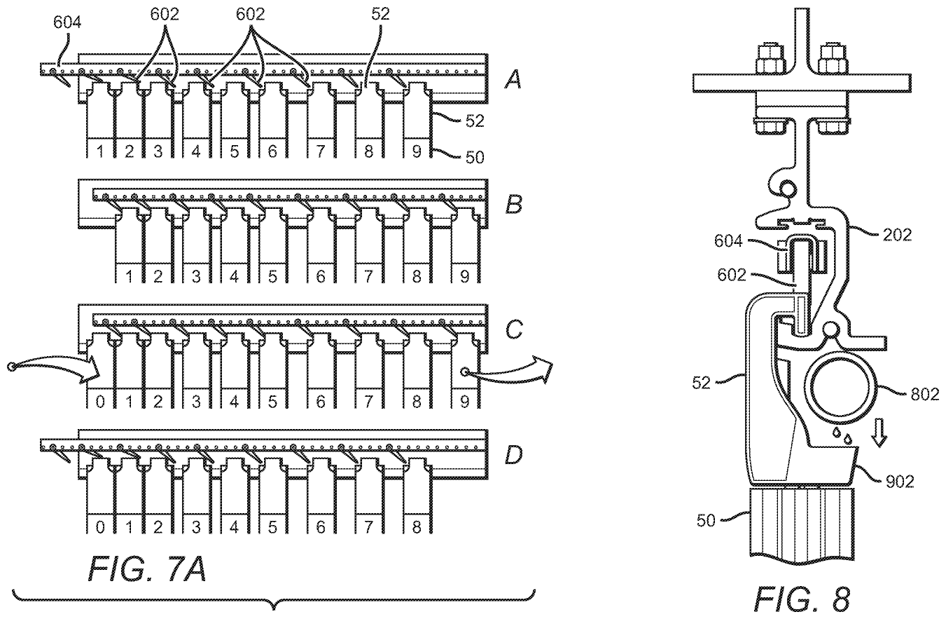

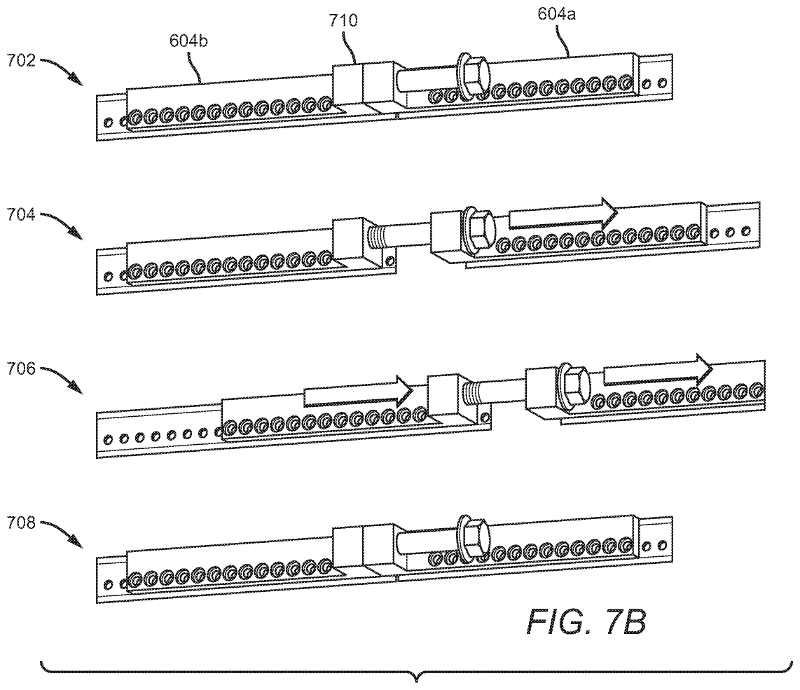

In embodiments of the disclosure, cam channel 604 attaches to a linear actuator, which operates in a forward and a back stroke. A suitable linear actuator may be the T13-B4010MS053-62 actuator offered by Thomson, Inc. of Redford, Va.; however, the reciprocating cam mechanism described herein can be operated with a variety of different actuators. The linear actuator may be attached to cam channel 604 at the off-loading end of a grow line 202, rather than the on-boarding end. In such a configuration, cam channel 604 is under tension when loaded by the towers 50 during a forward stroke of the actuator (which pulls the cam channel 604) which reduces risks of buckling. FIG. 7A illustrates operation of the reciprocating cam mechanism according to embodiments of the disclosure. In step A, the linear actuator has completed a full back stroke; as FIG. 7A illustrates, one or more cams 602 may ratchet over the hooks 52 of a grow tower 50. Step B of FIG. 7A illustrates the position of cam channel 604 and cams 602 at the end of a forward stroke. During the forward stroke, cams 602 engage corresponding grow towers 50 and move them in the forward direction along grow line 202 as shown. Step C of FIG. 7A illustrates how a new grow tower 50 (Tower 0) may be inserted onto a grow line 202 and how the last tower (Tower 9) may be removed. Step D illustrates how cams 602 ratchet over the grow towers 50 during a back stroke, in the same manner as Step A. The basic principle of this reciprocating cam mechanism is that reciprocating motion from a relatively short stroke of the actuator transports towers 50 in one direction along the entire length of the grow line 202. More specifically, on the forward stroke, all grow towers 50 on a grow line 202 are pushed forward one position. On the back stroke, the cams 602 ratchet over an adjacent tower one position back; the grow towers remain in the same location. As shown, when a grow line 202 is full, a new grow tower may be loaded and a last tower unloaded after each forward stroke of the linear actuator. In some implementations, the top portion of the hook 52 (the portion on which the cams push), is slightly narrower than the width of a grow tower 50. As a result, cams 602 can still engage with the hooks 52 when grow towers 50 are spaced immediately adjacent to each other. FIG. 7A shows 9 grow towers for didactic purposes. A grow line 202 can be configured to be quite long (for example, 40 meters) allowing for a much greater number of towers 50 on a grow line 202 (such as 400-450). Other implementations are possible. For example, the minimum tower spacing can be set equal to or slightly greater than two times the side-to-side distance of a grow tower 50 to allow more than one grow tower 50 to be loaded onto a grow line 202 in each cycle.

Still further, as shown in FIG. 7A, the spacing of cams 602 along the cam channel 604 can be arranged to effect one-dimensional plant indexing along the grow line 202. In other words, the cams 602 of the reciprocating cam mechanism can be configured such that spacing between towers 50 increases as they travel along a grow line 202. For example, spacing between cams 602 may gradually increase from a minimum spacing at the beginning of a grow line to a maximum spacing at the end of the grow line 202. This may be useful for spacing plants apart as they grow to increase light interception and provide spacing, and, through variable spacing or indexing, increasing efficient usage of the growth chamber 20 and associated components, such as lighting. In embodiments of the disclosure, the forward and back stroke distance of the linear actuator is equal to (or slightly greater than) the maximum tower spacing. During the back stroke of the linear actuator, cams 602 at the beginning of a grow line 202 may ratchet and overshoot a grow tower 50. On the forward stroke, such cams 602 may travel respective distances before engaging a tower, whereas cams located further along the grow line 202 may travel shorter distances before engaging a tower or engage substantially immediately. In such an arrangement, the maximum tower spacing cannot be two times greater than the minimum tower spacing; otherwise, a cam 602 may ratchet over and engaging two or more grow towers 50. If greater maximum tower spacing is desired, an expansion joint may be used, as illustrated in FIG. 7B. An expansion joint allows the leading section of the cam channel 604 to begin traveling before the trailing end of the cam channel 604, thereby achieving a long stroke. In particular, as FIG. 7B shows, expansion joint 710 may attach to sections 604a and 604b of cam channel 604. In the initial position (702), the expansion joint 710 is collapsed. At the beginning of a forward stroke (704), the leading section 604a of cam channel 604 moves forward (as the actuator pulls on cam channel 604), while the trailing section 604b remains stationary. Once the bolt bottoms out on the expansion joint 710 (706), the trailing section 604 of cam channel 604 begins to move forward as well. On the back stroke (708), the expansion joint 710 collapses to its initial position.

Other implementations for moving vertical grow towers 50 may be employed. For example, a lead screw mechanism may be employed. In such an implementation, the threads of the lead screw engage hooks 52 disposed on grow line 202 and move grow towers 50 as the shaft rotates. The pitch of the thread may be varied to achieve one-dimensional plant indexing. In another implementation, a belt conveyor include paddles along the belt may be employed to move grow towers 50 along a grow line 202. In such an implementation, a series of belt conveyors arranged along a grow line 202, where each belt conveyor includes a different spacing distance among the paddles to achieve one-dimensional plant indexing. In yet other implementations, a power-and-free conveyor may be employed to move grow towers 50 along a grow line 202.

### Irrigation & Aqueous Nutrient Supply

FIG. 8 illustrates how an irrigation line 802 may be attached to grow line 202 to supply an aqueous nutrient solution to crops disposed in grow towers 50 as they translate through the vertical tower conveyance system 200. Irrigation line 802, in embodiments of the disclosure, is a pressurized line with spaced-apart holes disposed at the expected locations of the towers 50 as they advance along grow line 202 with each movement cycle. For example, the irrigation line 802 may be a PVC pipe having an inner diameter of 1.5 inches and holes having diameters of 0.125 inches. The irrigation line 802 may be approximately 40 meters in length spanning the entire length of a grow line 202. To ensure adequate pressure across the entire line, irrigation line 802 may be broken into shorter sections, each connected to a manifold, so that pressure drop is reduced.

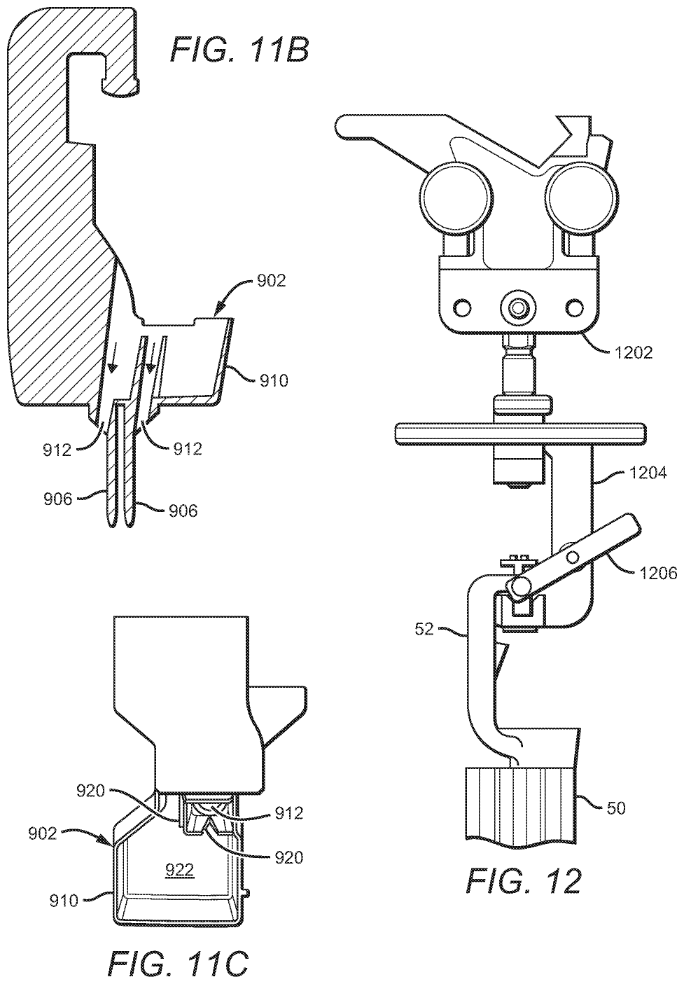

As FIG. 8 shows, a funnel structure 902 collects aqueous nutrient solution from irrigation line 802 and distributes the aqueous nutrient solution to the cavity(ies) 54a, 54b of the grow tower 50 as discussed in more detail below. FIGS. 9 and 11A illustrate that the funnel structure 902 may be integrated into hook 52. For example, the funnel structure 902 may include a collector 910, first and second passageways 912 and first and second slots 920. As FIG. 9 illustrates, the groove-engaging member 58 of the hook may disposed at a centerline of the overall hook structure. The funnel structure 902 may include flange sections 906 extending downwardly opposite the collector 910 and on opposing sides of the centerline. The outlets of the first and second passageways are oriented substantially adjacent to and at opposing sides of the flange sections 906, as shown. Flange sections 906 register with central wall 56 of grow tower 50 to center the hook 52 and provides additional sites to adhere or otherwise attach hook 52 to grow tower 50. In other words, when hook 52 is inserted into the top of grow tower 50, central wall 56 is disposed between flange sections 906. In the implementation shown, collector 910 extends laterally from the main body 53 of hook 52.

As FIG. 11B shows, funnel structure 902 includes a collector 910 that collects nutrient fluid and distributes the fluid evenly to the inner cavities 54a and 54b of tower through passageways 912. Passageways 912 are configured to distribute aqueous nutrient solution near the central wall 56 and to the center back of each cavity 54a, 54b over the ends of the plug holders 158 and where the roots of a planted crop are expected. As FIG. 11C illustrates, in embodiments of the disclosure, the funnel structure 902 includes slots 920 that promote the even distribution of nutrient fluid to both passageways 912. For nutrient fluid to reach passageways 912, it must flow through one of the slots 920. Each slot 920 may have a V-like configuration where the width of the slot opening increases as it extends from the substantially flat bottom surface 922 of collector 910. For example, each slot 920 may have a width of 1 millimeter at the bottom surface 922. The width of slot 920 may increase to 5 millimeters over a height of 25 millimeters. The configuration of the slots 920 causes nutrient fluid supplied at a sufficient flow rate by irrigation line 802 to accumulate in collector 910, as opposed to flowing directly to a particular passageway 912, and flow through slots 920 to promote even distribution of nutrient fluid to both passageways 912.

In operation, irrigation line 802 provides aqueous nutrient solution to funnel structure 902 that even distributes the water to respective cavities 54a, 54b of grow tower 50. The aqueous nutrient solution supplied from the funnel structure 902 irrigates crops contained in respective plug containers 158 as it trickles down. In embodiments of the disclosure, a gutter disposed under each grow line 202 collects excess water from the grow towers 50 for recycling.

Other implementations are possible. For example, the funnel structure may be configured with two separate collectors that operate separately to distribute aqueous nutrient solution to a corresponding cavity 54a, 54b of a grow tower 50. In such a configuration, the irrigation supply line can be configured with one hole for each collector. In other implementations, the towers may only include a single cavity and include plug containers only on a single face 101 of the towers. Such a configuration still calls for a use of a funnel structure that directs aqueous nutrient solution to a desired portion of the tower cavity, but obviates the need for separate collectors or other structures facilitating even distribution.

### Automated Pickup & Laydown Stations

As discussed above, the stations of central processing system 30 operate on grow towers 50 in a horizontal orientation, while the vertical tower conveyance system 200 conveys grow towers in the growth environment 20 in a vertical orientation. In embodiments of the disclosure, an automated pickup station 43, and associated control logic, may be operative to releasably grasp a horizontally-oriented grow tower from a loading location, rotate the tower to a vertical orientation and attach the tower to a transfer station for insertion into a selected grow line 202 of the growth environment 20. On the other end of growth environment 20, automated laydown station 41, and associated control logic, may be operative to releasably grasp and move a vertically-oriented grow tower 50 from a stop or pick location, rotate the grow tower 50 to a horizontal orientation and place it on a conveyance system for processing by one or more stations of central processing system 30. For example, automated laydown station 41 may place grow towers 50 on a conveyance system (such as a tower drive unit 2700 described below) for loading into harvester station 32. The automated laydown station 41 and pickup station 43 may each comprise a six-degrees of freedom (six axes) robotic arm, such as a FANUC robot. The stations 41 and 43 may also include end effectors for releasably grasping grow towers 50 at opposing ends, as described in more detail below.

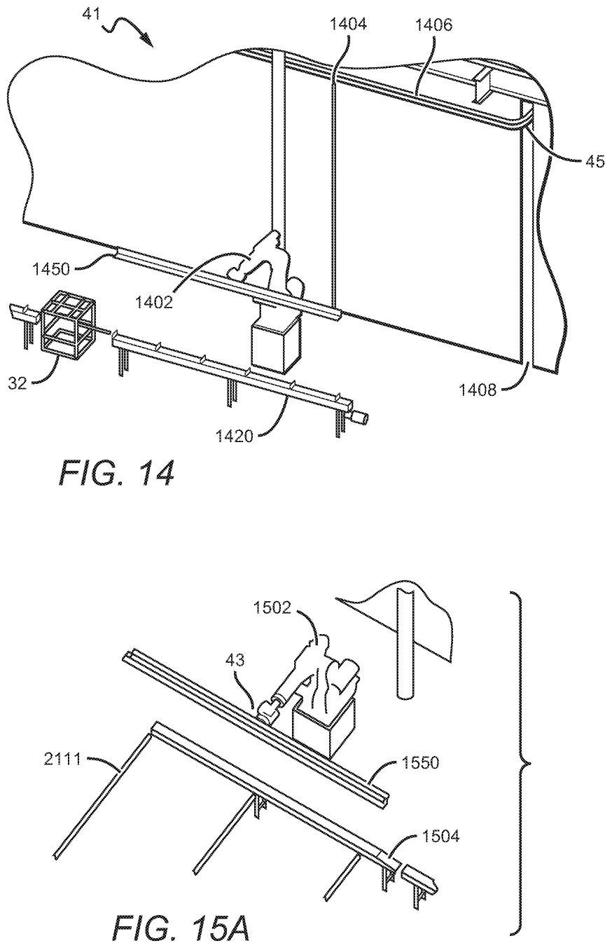

FIG. 14 illustrates an automated laydown station 41 according to embodiments of the disclosure. As shown, automated laydown station 41 includes robot 1402 and end effector 1450. Unload transfer conveyance mechanism 45, which may be a power and free conveyor, delivers grow towers 50 from growth environment 20. In embodiments of the disclosure, the buffer track section 1406 of unload transfer conveyance mechanism 45 extends through a vertical slot 1408 in growth environment 20, allowing mechanism 45 to convey grow towers 50 attached to carriages 1202 outside of growth environment 20 and towards pick location 1404. Unload transfer conveyance mechanism 45 may use a controlled stop blade to stop the carriage 1202 at the pick location 1404. The unload transfer conveyance mechanism 45 may include an anti-roll back mechanism, bounding the carriage 1202 between the stop blade and the anti-roll back mechanism.

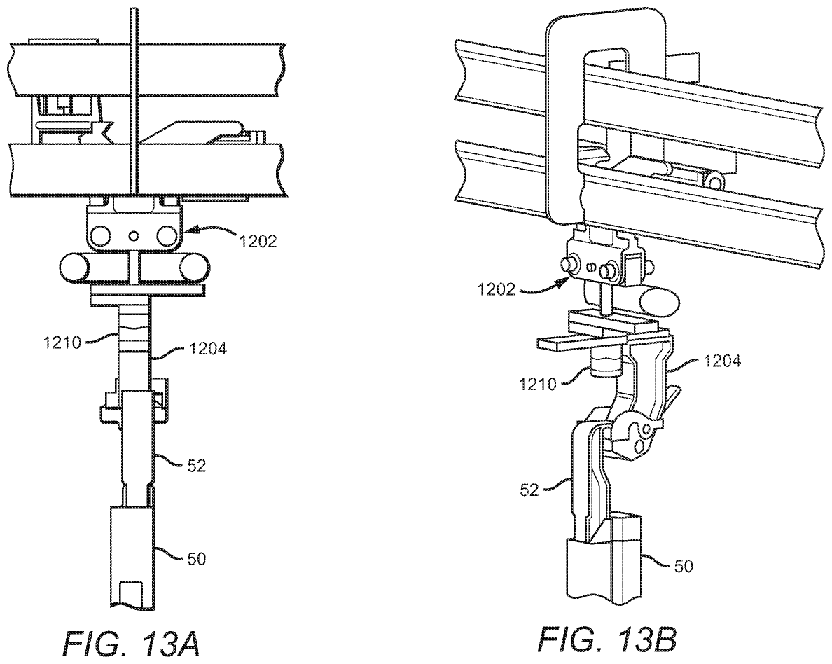

As FIGS. 12, 13A and 13B illustrate, receiver 1204 may be attached to a swivel mechanism 1210 allowing rotation of grow towers 50 when attached to carriages 1202 for closer buffering in unload transfer conveyance mechanism 45 and/or to facilitate the correct orientation for loading or unloading grow towers 50. In some implementations, for the laydown location and pick location 1404, grow towers 50 may be oriented such that hook 52 faces away from the automated laydown and pickup stations 41, 43 for ease of transferring towers on/off the swiveled carriage receiver 1204. Hook 52 may rest in a groove in the receiver 1204 of carriage 1202. Receiver 1204 may also have a latch 1206 which closes down on either side of the grow tower 50 to prevent a grow tower 50 from sliding off during acceleration or deceleration associated with transfer conveyance.

FIG. 16 illustrates an end effector 1450, according to embodiments of the disclosure, that provides a gripping solution for releasably grasping a grow tower 50 at opposing ends. End effector 1450 may include a beam 1602 and a mounting plate 1610 for attachment to a robot, such as robotic arm 1402, or other actuator. A top gripper assembly 1604 and a bottom gripper assembly 1606 are attached to opposite ends of beam 1602. End effector 1450 may also include support arms 1608 to support a grow tower 50 when held in a horizontal orientation. For example, support arms 1608 extending from a central section of beam 1602 may be used to mitigate tower deflection. Support arms 1608 may be spaced —1.6 meters from either gripper assembly 1604, 1606, and may be nominally 30 mm offset from a tower face, allowing 30 mm of tower deflection before the support arms 1608 catch the grow tower 50.

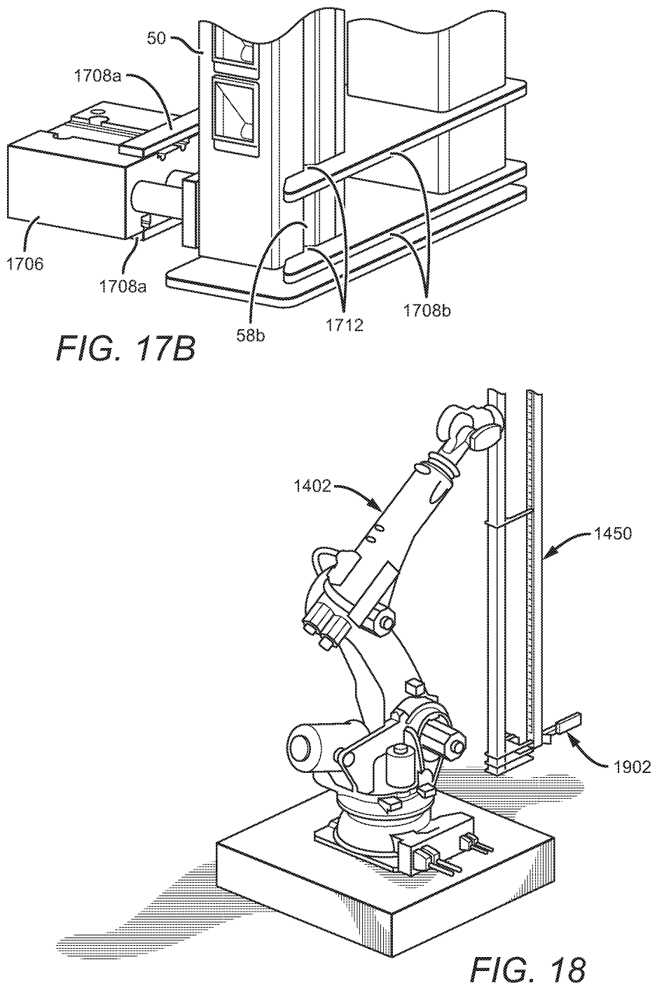

Bottom gripper assembly 1606, as shown in FIGS. 17A and 17B, may include plates 1702 extending perpendicularly from an end of beam 1602 and each having a cut-out section 1704 defining fingers 1708a and 1708b. An actuator 1706, such as a pneumatic cylinder mechanism (for example, a guided pneumatic cylinder sold by SMC Pneumatics under the designation MGPM40-40Z) attaches to fingers 1708a of plates 1702. Fingers 1708b may include projections 1712 that engage groove 58b of grow tower 50 when grasped therein to locate the grow tower 50 in the gripper assembly 1606 and/or to prevent slippage. The gripper assembly 1606, in the implementation shown, operates like a lobster claw—i.e., one side of the gripper (the actuator 1706) moves, while the opposing side (fingers 1708b) remain static. On the static side of the gripper assembly 1606, the actuator 1706 drives the grow tower 50 into the fingers 1708b, registering the tower 50 with projections 1712. Friction between a grow tower 50 and fingers 1708b and pneumatic cylinder mechanism 1706 holds the grow tower 50 in place during operation of an automated laydown or pick up station 41, 43. To grasp a grow tower 50, the actuator 1706 may extend from a retracted position. In such an implementation, actuator 1706 is retracted to a release position during a transfer operation involving the grow towers 50. Robot 1402 then moves end effector 1450 to position the gripper assemblies 1604, 1606 over the grow tower 50. In implementations where the actuator 1706 is a pneumatic mechanism, the solenoid of the pneumatic cylinder mechanism may be center-closed in that, whether extended or retracted, the valve locks even if air pressure is lost. In such an implementation, loss of air pressure will not cause a grow tower 50 to fall out of end effector 1450 while the pneumatic cylinder mechanism is extended.

Top gripper assembly 1604, in embodiments of the disclosure, is essentially a mirror image of bottom gripper assembly 1606, as it includes the same components and operates in the same manner described above. Catch plate 1718, in embodiments of the disclosure, may attach only to bottom gripper assembly 1606. Catch plate 1718 may act as a safety catch in case the gripper assemblies fail or the grow tower 50 slips. Other implementations are possible. For example, the gripper assemblies may be parallel gripper assemblies where both opposing arms of each gripper move when actuated to grasp a grow tower 50. In some implementations, the gripper assemblies 1604, 1606 may be welded to beam 1602. In other implementations, the gripper assemblies 1604, 1606 may include brackets or other features that allow the assemblies to attach to beam 1602 with bolts, screws or other fasteners.

Robot 1402 may be a 6-axis robotic arm including a base, a lower arm attached to the base, an upper arm attached to the lower arm, and a wrist mechanism disposed between the end of the upper arm and an end effector 1450. For example, robot 1402 may 1) rotate about its base; 2) rotate a lower arm to extend forward and backward; 3) rotate an upper arm, relative to the lower arm, upward and downward; 4) rotate the upper arm and attached wrist mechanism in a circular motion; 5) tilt a wrist mechanism attached to the end of the upper arm up and down; and/or 6) rotate the wrist mechanism clockwise or counter-clockwise. However, modifications to end effector 1450 (and/or other elements, such as conveyance mechanisms and the like) may permit different types of robots and mechanisms, as well as use of robots with fewer axes of movement. As FIG. 18 illustrates, robot 1402 may be floor mounted and installed on a pedestal. Inputs to the robot 1402 may include power, a data connection to a control system, and an air line connecting the actuator 1706 (in implementations, involving a pneumatic cylinder mechanism) to a pressurized air supply. On actuator 1706, sensors may be used to detect when the actuator is in its open state or its closed state. The control system may execute one or more programs or sub-routines to control operation of the robot 1402 to effect conveyance of grow towers 50 from growth environment 20 to central processing system 30.

As discussed herein, grow towers may be relatively narrow and long structures that are comprised of an extruded plastic material. One or both of the lateral faces of the grow tower may include grow sites. The modeled or designed configuration of a grow tower assumes that the that the opposing lateral face does not vary along the x- or y-axis along the length of the tower. Grow towers in reality, however, vary across the x- and y-axes due, for example, to manufacturing tolerances and/or various loads placed on the towers. For example, a grow tower 50 may curve slightly along its length. This may present certain challenges when performing various operations on the grow tower, such as locating the opposing ends of a grow tower 50 during an automated pickup or laydown operation. Furthermore, when a grow tower 50 accelerates/decelerates in unload transfer conveyance mechanism 45, the grow tower 50 may swing slightly from its attachment point.

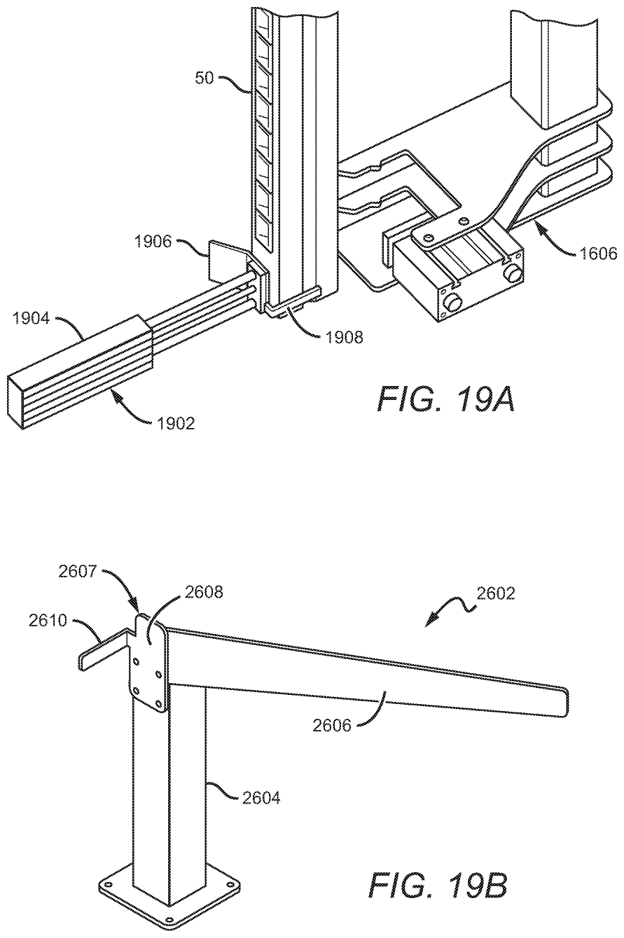

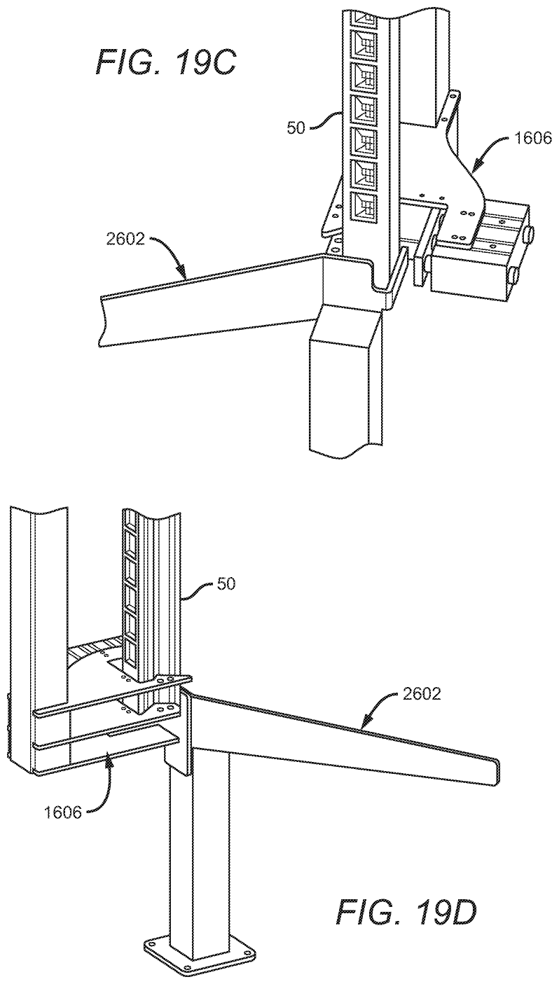

FIGS. 18 and 19A illustrate a tower constraining mechanism 1902 to stop possible swinging, and to accurately locate, a grow tower 50 during a laydown operation of automated laydown station 41. In the implementation shown, mechanism 1902 is a floor-mounted unit that includes a guided pneumatic cylinder 1904 and a bracket assembly including a guide plate 1906 that guides a tower 50 and a bracket arm 1908 that catches the bottom of the grow tower 50, holding it at a slight angle to better enable registration of the grow tower 50 to the bottom gripper assembly 1606. A control system may control operation of mechanism 1902 to engage the bottom of a grow tower 50, thereby holding it in place for gripper assembly 1606.

Other implementations are possible. FIG. 19B, for example, illustrates a lead-in feature 2602 that facilitates registration and location of a grow tower 50 at a pick location 1404 prior to initiation of a laydown operation. Lead-in feature 2602, in embodiments of the disclosure, is a floor-mounted unit that includes stand 2604. Lead-in feature 2602 further includes ramp section 2606 and nest portion 2607. Nest portion 2607 includes face 2608 and arm 2610 that extends perpendicular to face 2608. Lead-in feature 2602 is located in the region of stop location 1404 with ramp section 2606 located in the travel path of a grow tower 50 as it is conveyed to stop location 1404 by unload transfer conveyance mechanism 45. As unload transfer conveyance mechanism 45 conveys a grow tower 50 to stop location 1404, the bottom end of grow tower 50 may contact and slide along ramp section 2606. Ramp section 2606 guides the grow tower 50 toward nest portion 2607 as grow tower 50 is conveyed to stop location 1404. The length and angle of ramp section 2606 are configured to accommodate for potential swinging of grow tower 50 as it translates to pick location 1404. In embodiments of the disclosure, ramp section 2606 is angled at ˜25 degrees. Although not show, stand 2604 may be retractable to allow grow towers 50 to pass over lead-in feature 2602 in certain modes and engage lead-in feature 2602 in other modes.

Nest portion 2607 is configured to engage the bottom end of grow tower 50 before the top end of grow tower 50 reaches the stop location 1404. In other words, when grow tower 50 reaches stop location 1404, face 2608 and arm 2610 of nest portion 2607 engage a corner of the bottom end of grow tower 50 holding the bottom end at a slight offset to hook 52 (the top of grow tower 50) in both the x- and y-dimensions. In embodiments of the disclosure, the offset between a) the expected (or designed) location of the corner of grow tower 50 (assuming no curvature or other variation of grow tower 50) without lead-in feature 2602, and b) the corner defined by face 2608 and arm 2610 of nest portion 2607 is ˜1.5 inches in both the x-and y-dimensions. Grow towers 50, therefore, rest at a slight angle to vertical when translated to stop location 1404 and engaged in nest portion 2607 of lead-in feature 2602. In embodiments of the disclosure, arm 2610 is ˜6 inches long to catch grow towers 50 that may bounce from lead-in feature 2602 as they are conveyed to stop location 1404. This configuration has at least two advantages. The configuration causes the grow tower 50 to rest in nest portion 2607 and prevents swinging of the grow tower 50 when it reaches stop location 1404. It also allows the laydown station 41 to more accurately locate both ends of grow tower 50, which may be warped due to either manufacturing tolerances or to deflection under load. FIGS. 19C and 19D are different viewpoints illustrating how lead-in feature 2602 engages the bottom end of grow tower 50. These Figures also operate how lead-in feature 2602 facilitates location of the bottom end of grow tower 50 for grasping by gripper assembly 1606.

The end state of the laydown operation is to have a grow tower 50 laying on the projections 2004 of the harvester infeed conveyor 1420, as centered as possible, according to embodiments of the disclosure. Projections 2004 of harvester infeed conveyor 1420 facilitate the laydown operation by allowing the gripper assemblies 1604, 1606 and end effector 1450 to travel in the area between the conveyor surface and the top of projections 2004 and release the grow tower 50 on projections 2004. In embodiments of the disclosure, a grow tower 50 is oriented such that hook 52 points towards harvester station 32 and, in implementations having hinged side walls, and hinge side down. (According to other embodiments, the infeed conveyor 1420 may instead be implemented using a tower drive unit 2700 such as that described below.) The following summarizes the decisional steps that a controller for robot 1402 may execute during a laydown operation, according to embodiments of the disclosure.

### Laydown Procedure Description

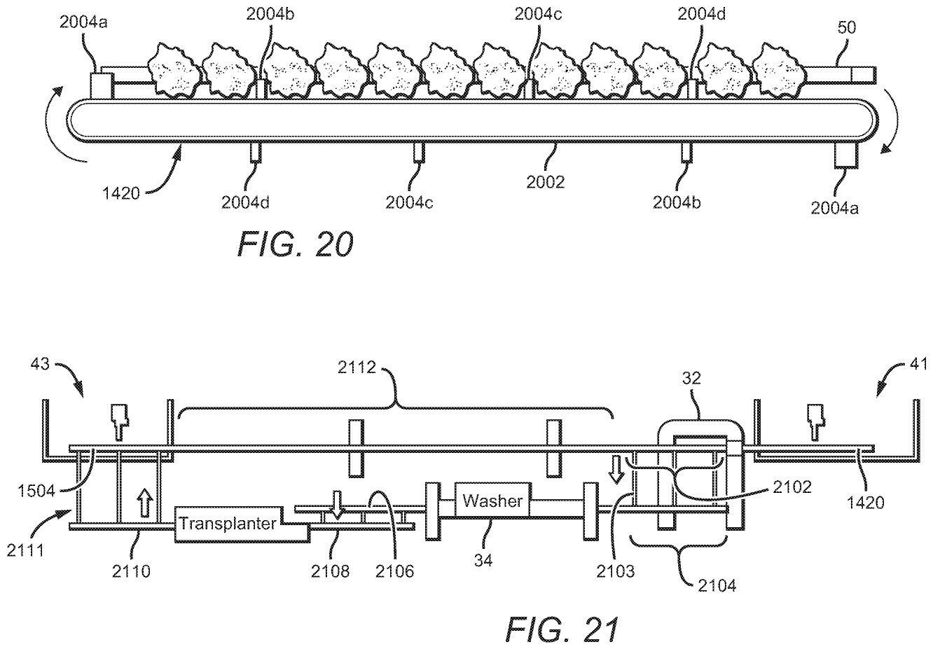

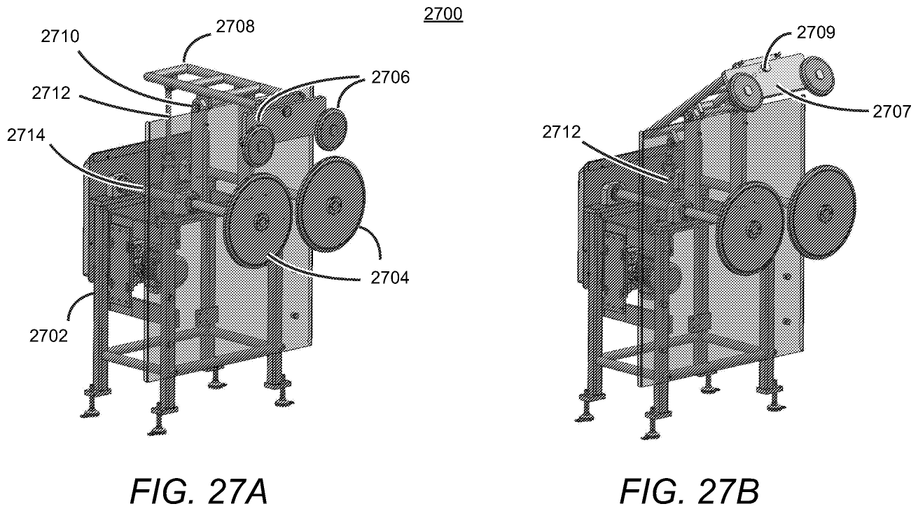

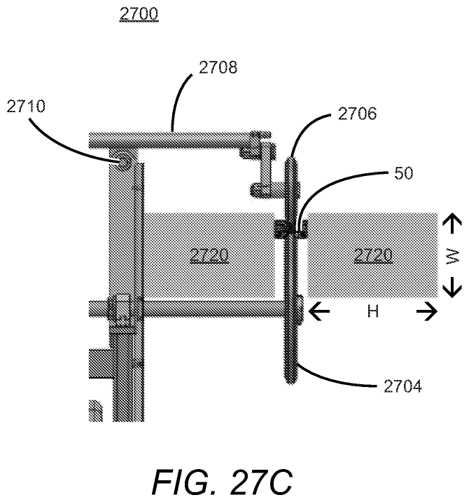

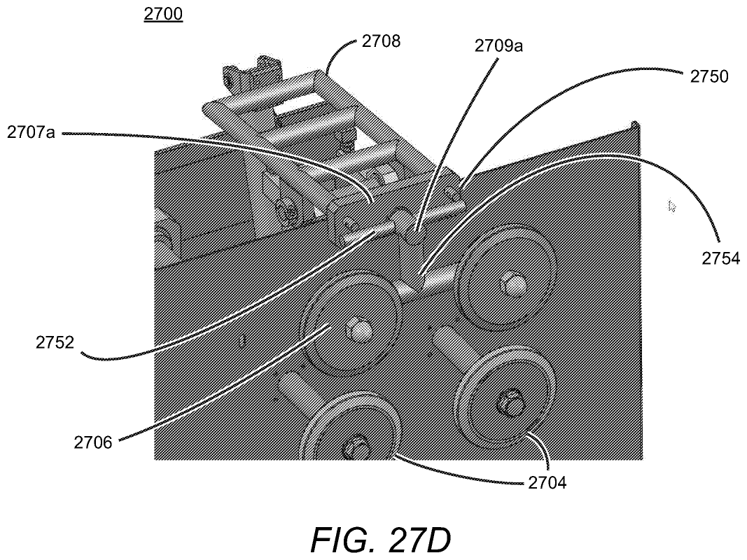

The Main program for the robot controller may work as follows:
A control system associated with central processing system 30 may activate the robot controller's Main program.
Within the Main program, the robot controller may check if robot 1402 is in its home position.
If robot 1402 is not in its home position, it enters its Home program to move to the home position.
The Main program then calls the reset I/O program to reset all the I/O parameters on robot 1402 to default values.
Next, the Main program runs the handshake program with the central processing controller to make sure a grow tower 50 is present at the pickup location 1404 and ready to be picked up.
The Main program may run an enter zone program to indicate it is about to enter the transfer conveyance zone.
The Main program may run a Pick Tower program to grasp a grow tower 50 and lift it off of carriage 1202.
The Main program may then call the exit zone program to indicate it has left the transfer conveyance zone.
Next the Main program runs the handshake program with the central processing controller to check whether the harvester infeed conveyor 1420 is clear and in position to receive a grow tower 50.
The Main program may then run the enter zone program to indicate it is about to enter the harvester infeed conveyor zone.
The Main program runs a Place Tower program to move and place the picked tower onto the infeed conveyor 1420 (which may, for example, be implemented using the conveyor of FIG. 20 or the instead as the tower drive unit 2700 of FIGS. 27A-C described below.
The Main program then calls an exit zone program to indicate it has left the harvester infeed conveyor zone.
The Home program may then run to return robot 1402 to its home position.
Lastly, the Main program may run the handshake program with the central processing controller to indicate robot 1402 has returned to its home position and is ready to pick the next grow tower 50.

The Pick Tower program may work as follows:
Robot 1402 checks to make sure the grippers 1604, 1606 are in the open position. If the grippers are not open, robot 1402 will throw an alarm.
Robot 1402 may then begin to move straight ahead which will push the end effector 1450 into the tower face so that the grow tower is fully seated against the back wall of the grippers 1604, 1606.
Robot 1402 may then move sideways to push the rigid fingers 1712 against the tower walls to engage groove 58b.
Robot 1402 may activate robot outputs to close the grippers 1604, 1606.
Robot 1402 may wait until sensors indicate that the grippers 1604, 1606 are closed. If robot 1402 waits too long, robot 1402 may throw an alarm.
Once grip is confirmed, robot 1402 may then move vertically to lift grow tower 50 off of the receiver 1204.
Next, robot 1402 may then pull back away from pick location 1404.

The Place Tower program may work as follows:
Robot 1402 may move through two waypoints that act as intermediary points to properly align grow tower 50 during the motion.
Robot 1402 continues on to position end effector 1450 and grow tower 50 just above the center of the harvester in-feed conveyor 1420, such that the tower is in the correct orientation (e.g., hinge down on the rigid fingers, hook 52 towards harvester station 32).
Once the conveyor position is confirmed, robot 1402 may then activate the outputs to open grippers 1604, 1606 so that grow tower 50 is just resting on the rigid fingers 1712 and support arms 1608.
Robot 1402 may wait until the sensors indicate that grippers 1604, 1606 have opened. If robot 1402 waits too long, robot 1402 may throw an alarm.
After grippers 1604, 1606 are released, robot 1402 may then move vertically down. On the way down the projections 2004 of harvester infeed conveyor 1420 take the weight of grow tower 50 and the rigid fingers 1712 and support arms 1608 of end effector 1450 end up under grow tower and not in contact.
Lastly, robot 1402 may then pull end effector 1450 towards robot 1402, away from harvester infeed conveyor 1420, and slides rigid fingers 1712 of end effector 1450 out from under grow tower 50.
In alternative embodiments employing a tower drive unit 2700 such as that described below, instead of placing the grow tower 50 into harvester in-feed conveyor 1420 such as that shown in FIG. 20, the robot 1402 places the grow tower 50 into the tower drive unit 2700 as described below.

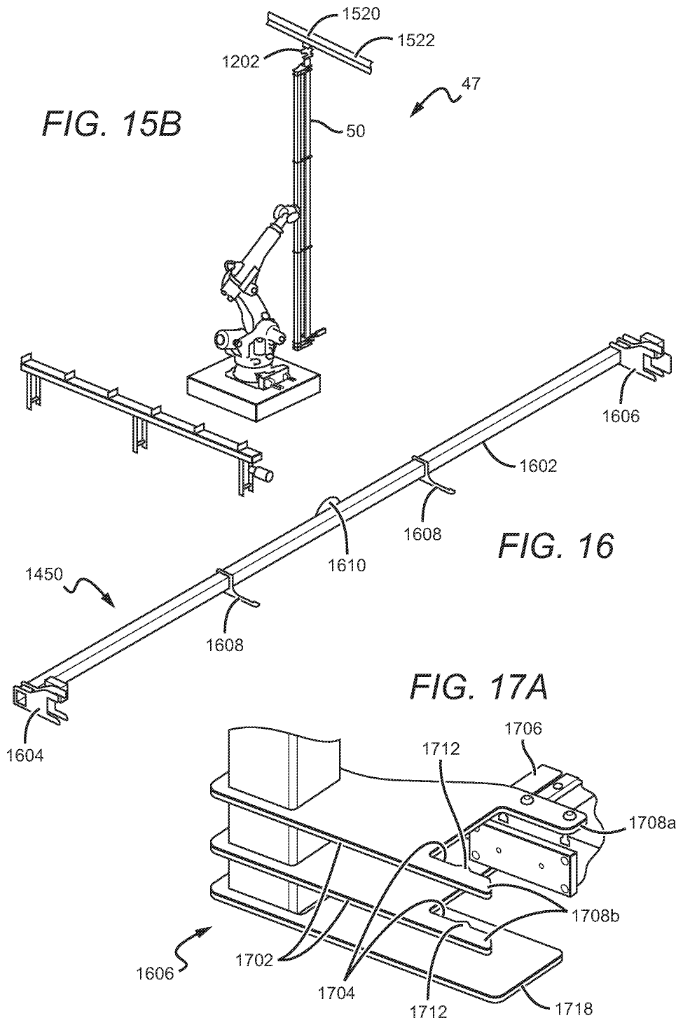

FIGS. 15A and 15B illustrate an automated pickup station 43 according to embodiments of the disclosure. As shown, automated pickup station 43 includes robot 1502 and pickup conveyor 1504. Similar to automated laydown station 41, robot 1502 includes end effector 1550 for releasably grasping grow towers 50. In embodiments of the disclosure, end effector 1550 is substantially the same as end effector 1450 attached to robot 1402 of automated laydown station 41. In embodiments of the disclosure, end effector 1550 may omit support arms 1608. According to embodiments of the disclosure, robot 1502, using end effector 1550, may grasp a grow tower 50 resting on pickup conveyor 1504 (which may be implemented using a belt or roller conveyor or as a tower drive unit 2700 such as that described below), rotate the grow tower 50 to a vertical orientation and attach the grow tower 50 to a carriage 1202 of loading transfer conveyance mechanism 47. As discussed above, loading transfer conveyance mechanism 47, which may include be a power and free conveyor, delivers grow towers 50 to growth environment 20. In embodiments of the disclosure, the buffer track section 1522 of loading transfer conveyance mechanism 47 extends through a vertical slot in growth environment 20, allowing mechanism 47 to convey grow towers 50 attached to carriages 1202 into growth environment 20 from stop location 1520. Loading transfer conveyance mechanism 47 may use a controlled stop blade to stop the carriage 1202 at the stop location 1520. The loading transfer conveyance mechanism 47 may include an anti-roll back mechanism, bounding the carriage 1202 between the stop blade and the anti-roll back mechanism.

### Central Processing System

As discussed above, central processing system 30 may include harvester station 32, washing station 34 and transplanter station 36. Central processing system 30 may also include one or more conveyors to transfer towers to or from a given station. For example, referring to FIG. 21, central processing system 30 may include harvester outfeed conveyor 2102, washer infeed conveyor 2104, washer outfeed conveyor 2106, transplanter infeed conveyor 2108, and transplanter outfeed conveyor 2110. These conveyors can be belt conveyor, roller conveyors, tower drive units 2700 or other mechanisms that convey horizontally-disposed grow towers 50. As described herein, central processing system 30 may also include one or more sensors for identifying grow towers 50 and one or more controllers for coordinating and controlling the operation of various stations and conveyors.

Washing station 34 may employ a variety of mechanisms to clean crop debris (such as roots and base or stem structures) from grow towers 50. To clean a grow tower 50, washing station 34 may employ pressurized water systems, pressurized air systems, mechanical means (such as scrubbers, scrub wheels, scrapers, etc.), or any combination of the foregoing systems. In implementations that use hinged grow towers (such as those discussed above), the washing station 34 may include a plurality of substations including a substation to open the front faces 101 of grow towers 50 prior to one or more cleaning operations, and a second substation to close the front faces 101 of grow towers after one or more cleaning operations.

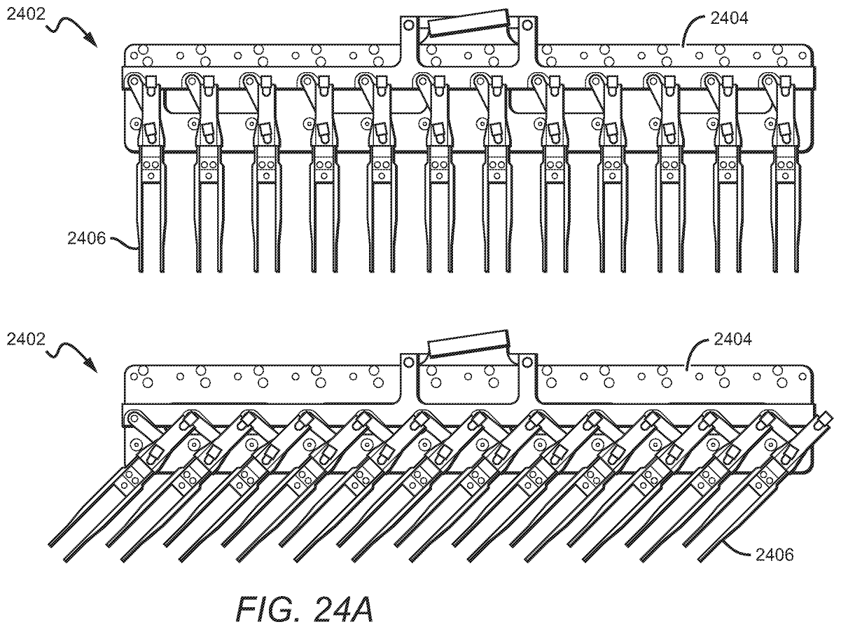

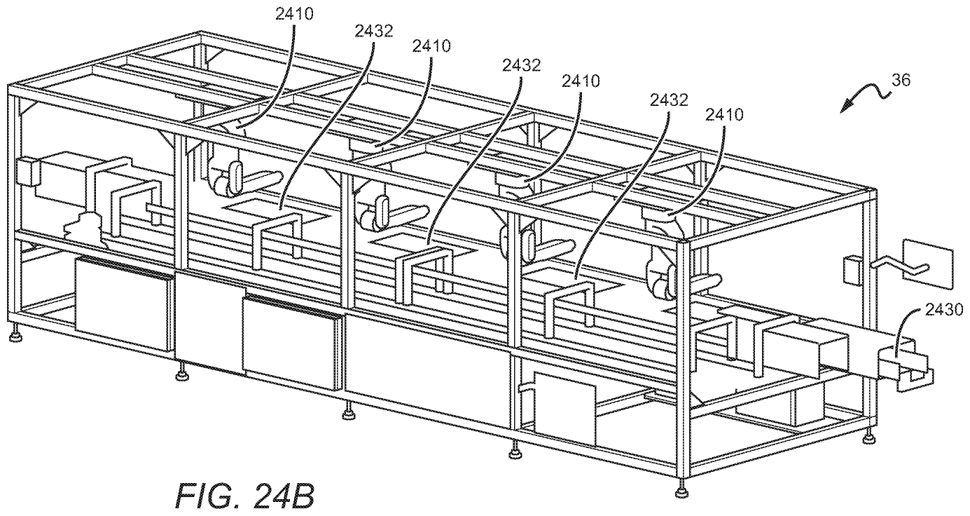

Transplanter station 36, in embodiments of the disclosure, includes an automated mechanism to inject seedlings into grow sites 53 of grow towers 50. In embodiments of the disclosure, the transplanter station 36 receives plug trays containing seedlings to be transplanted into the grow sites 53. In embodiments of the disclosure, transplanter station 36 includes a robotic arm and an end effector that includes one or more gripper or picking heads that grasps root-bound plugs from a plug tray and inserts them into grow sites 53 of grow tower 53. For implementations where grow sites 53 extend along a single face of a grow tower, the grow tower may be oriented such that the single face faces upwardly. For implementations where grow sites 53 extend along opposing faces of a grow tower 50, the grow tower 50 may be oriented such that the opposing faces having the grow sites face laterally. FIGS. 24A and 24B illustrate an example transplanter station. Transplanter station 36 may include a plug tray conveyor 2430 that positions plug trays 2432 in the working envelope of a robotic arm 2410. Transplanter station 36 may also include a feed mechanism that loads a grow tower 50 into place for transplanting. Transplanter station 36 may include one or more robotic arms 2410 (such as a six-axis robotic arm), each having an end effector 2402 that is adapted to grasp a root-bound plug from a plug tray and inject the root bound plug into a grow site 53 of a grow tower. FIG. 24A illustrates an example end effector 2402 that includes a base 2404 and multiple picking heads 2406 extending from the base 2404. The picking heads 2406 are each pivotable from a first position to a second position. In a first position (top illustration of FIG. 24A), a picking head 2406 extends perpendicularly relative to the base. In the second position shown in FIG. 24A, each picking head 2406 extends at a 45-degree angle relative to the base 2404. The 45-degree angle may be useful for injecting plugs into the plug containers 158 of grow towers that, as discussed above, extend at a 45-degree angle. A pneumatic system may control the pivoting of the picking heads between the first position and the second position. In operation, the picking heads 2406 may be in the first position when picking up root-bound plugs from a plug tray, and then may be moved to the second position prior to insertion of the plugs into plug containers 158. In such an insertion operation, the robotic arm 2410 can be programmed to insert in a direction of motion parallel with the orientation of the plug container 158. Using the end effector illustrated in FIG. 24A, multiple plug containers 158 may be filled in a single operation. In addition, the robotic arm 2410 may be configured to perform the same operation at other regions on one or both sides of a grow tower 50. As FIG. 24B shows, in embodiments of the disclosure, several robotic assemblies, each having an end effector 2402 are used to lower processing time. After all grow sites 53 are filled, the grow tower 50 is ultimately conveyed to automated pickup station 43, as described herein.

FIG. 21 illustrates an example processing pathway for central processing system 30. As discussed above, a robotic picking station 41 may lower a grow tower 50 with mature crops onto a harvester infeed conveyor 1420, which conveys the grow tower 50 to harvester station 32. FIG. 20 illustrates a harvester infeed conveyor 1420 according to embodiments of the disclosure. Harvester infeed conveyor 1420 may be a belt conveyor having a belt 2002 including projections 2004 extending outwardly from belt 2002. (As describe elsewhere herein, harvester infeed conveyor 1420 may alternatively be implemented as a belt conveyor, a roller conveyor, a tower drive unit 2700 or another conveyance mechanism.) Projections 2004 provide for a gap between belt 2002 and crops extending from grow tower 50, helping to avoid or reduce damage to the crops. In embodiments of the disclosure, the size of the projections 2004 can be varied cyclically at lengths of grow tower 50. For example, projection 2004a may be configured to engage the end of grow tower 50; top projection 2004d may engage the opposite end of grow tower 50; and middle projections 2004b, c may be positioned to contact grow tower 50 at a lateral face where the length of projections 2004b, c are lower and engage grow tower 50 when the tower deflects beyond a threshold amount. The length of belt 2002, as shown in FIG. 20 can be configured to provide for two movement cycles for a grow tower 50 for each full travel cycle of the belt 2002. In other implementations, however, all projections 2004 are uniform in length.

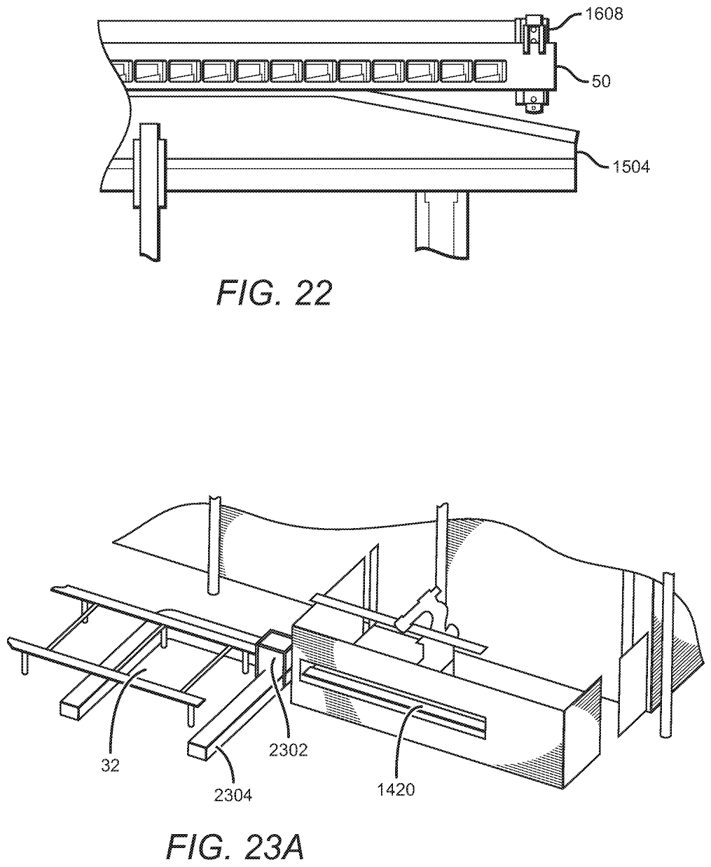

As FIG. 21 shows, harvester outfeed conveyor 2102 conveys grow towers 50 that are processed from harvester station 32. (For example, harvester outfeed conveyor 2102 may be implemented as a belt conveyor, a roller conveyor, a tower drive unit 2700 or another conveyance mechanism.) In the implementation shown, central processing system 30 is configured to handle two types of grow towers: “cut-again” and “final cut.” As used herein, a “cut-again” tower refers to a grow tower 50 that has been processed by harvester station 32 (i.e., the crops have been harvested from the plants growing in the grow tower 50, but the root structure of the plant(s) remain in place) and is to be re-inserted in growth environment 20 for crops to grow again. As used herein, a “final cut” tower refers to a grow tower 50 where the crops are harvested and where the grow tower 50 is to be cleared of root structure and growth medium and re-planted. Cut-again and final cut grow towers 50 may take different processing paths through central processing system 30. To facilitate routing of grow towers 50, central processing system 30 includes sensors (e.g., RFID, barcode, or infrared) at various locations to track grow towers 50. Control logic implemented by a controller of central processing system 30 tracks whether a given grow tower 50 is a cut-again or final cut grow tower and causes the various conveyors to route such grow towers accordingly. For example, sensors may be located at pick position 1404 and/or harvester infeed conveyor 1420, as well as at other locations. The various conveyors described herein can be controlled to route identified grow towers 50 along different processing paths of central processing system 30. As shown in FIG. 21, a cut-again conveyor 2112 transports a cut-again grow tower 50 toward the work envelope of automated pickup station 43 for insertion into grow environment 20. Cut-again conveyor 2112 may consist of either a single accumulating conveyor or a series of conveyors. Cut-again conveyor 2112 (which may, for example, be implemented as a belt conveyor, a roller conveyor, a tower drive unit 2700 or another conveyance mechanism) may convey a grow tower 50 to pickup conveyor 1504. In embodiments of the disclosure, pickup conveyor 1504 is configured to accommodate end effector 1450 of automated pickup station 43 that reaches under grow tower 50. Methods of accommodating the end effector 1450 include either using a conveyor section that is shorter than grow tower 50 or using a conveyor angled at both ends as shown in FIG. 22.

Final cut grow towers 50, on the other hand, travel through harvester station 32, washing station 34 and transplanter 36 before reentering growth environment 20. With reference to FIG. 21, a harvested grow tower 50 may be transferred from harvester outfeed conveyor 2102 to a washer transfer conveyor 2103. The washer transfer conveyor 2103 moves the grow tower onto washer infeed conveyor 2104, which feeds grow tower 50 to washing station 34. In embodiments of the disclosure, pneumatic slides may push a grow tower 50 from harvester outfeed conveyor 2102 to washer transfer conveyor 2103. Washer transfer conveyor 2103 may be a three-strand conveyor that transfers the tower to washer infeed conveyor 2104. (Washer transfer conveyor 2103 and washer infeed conveyor 2104 may, for example, each be implemented as a belt conveyor, a roller conveyor, a tower drive unit 2700, or another conveyance mechanism.) Additional pusher cylinders may push the grow tower 50 off washer transfer conveyor 2103 and onto washer infeed conveyor 2104. A grow tower 50 exits washing station 34 on washer outfeed conveyor 2106 and, by way of a push mechanism, is transferred to transplanter infeed conveyor 2108. The cleaned grow tower 50 is then processed in transplanter station 46, which inserts seedlings into grow sites 53 of the grow tower. Transplanter outfeed conveyor 2110 transfers the grow tower 50 to final transfer conveyor 2111, which conveys the grow tower 50 to the work envelope of automated pickup station 43.

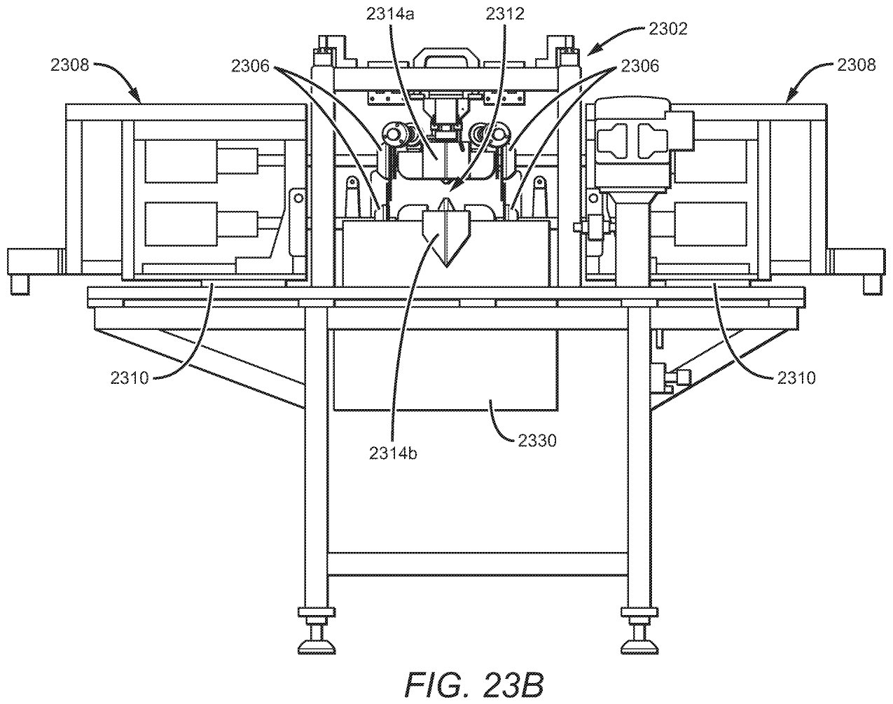

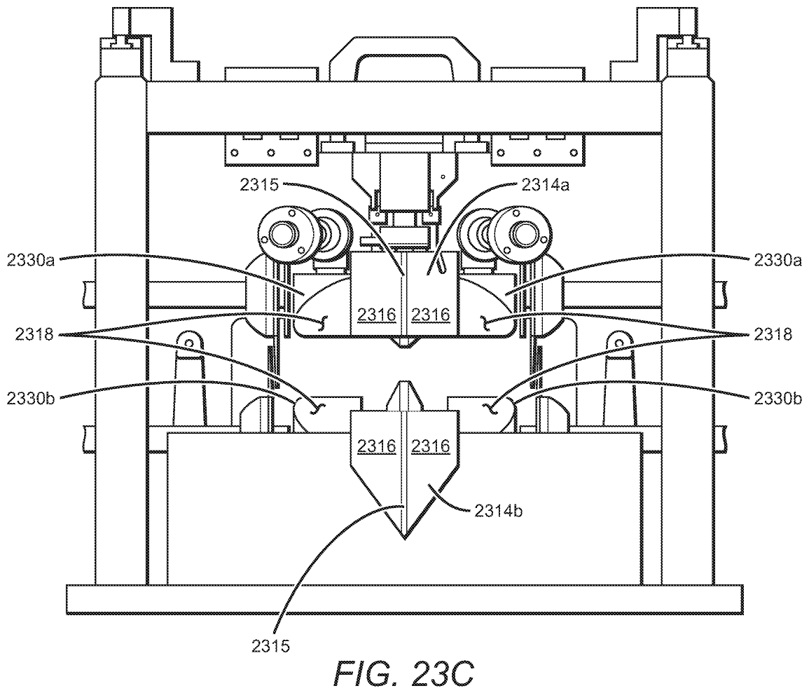

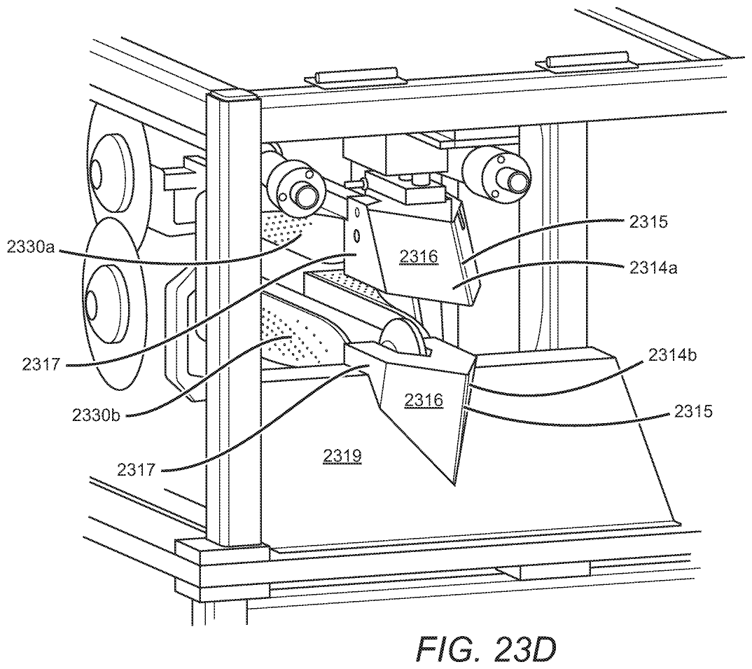

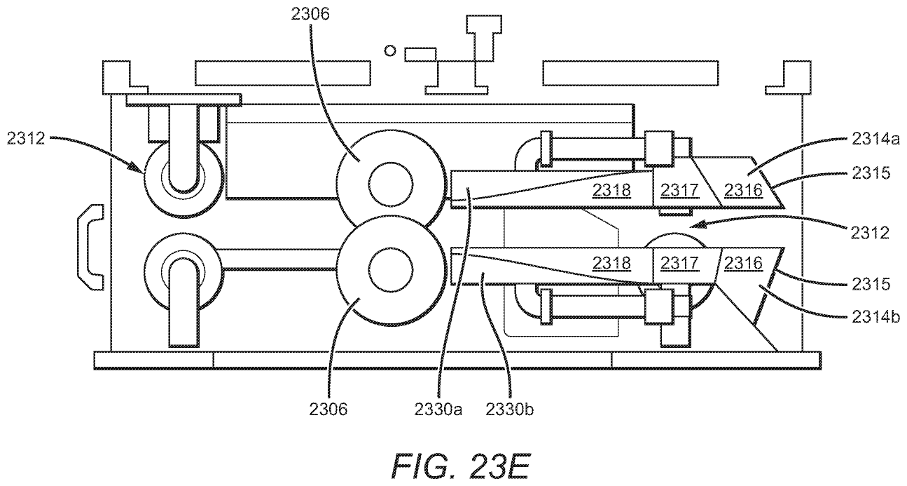

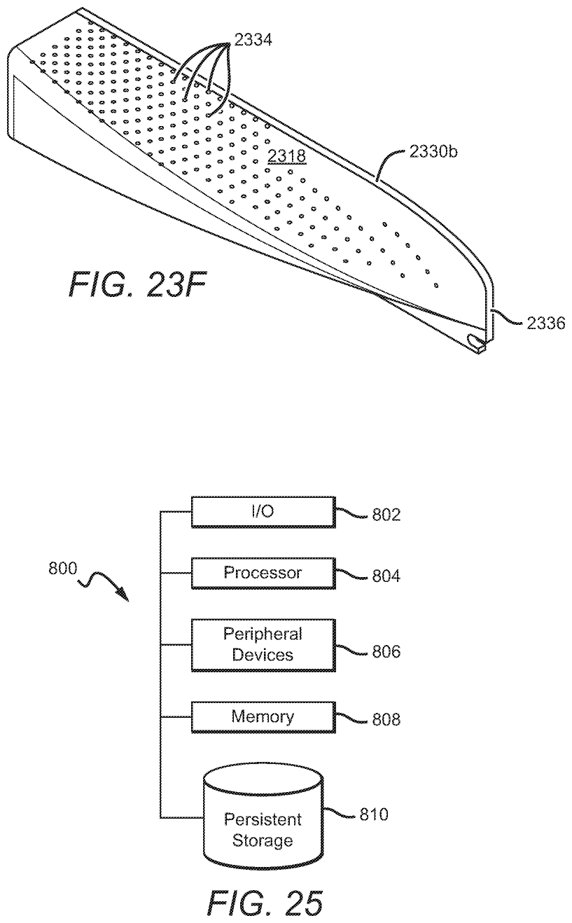

In the implementation shown in FIG. 23A, harvester station 34 comprises crop harvester machine 2302 and bin conveyor 2304. According to embodiments of the disclosure, grow towers 50 enter the harvester machine 2302 full of mature plants and leave the harvester machine 2302 with remaining stalks and soil plugs to be sent to the next processing station. Harvester machine 2302 may include a rigid frame to which various components, such as cutters and feed assemblies, are mounted. Harvester machine 2302, in embodiments of the disclosure, includes its own infeed mechanism that engages a grow tower 50 and feeds it through the machine for processing. In embodiments of the disclosure, harvester machine 2302 engages a grow tower 50 on the upper and lower faces (the faces that do not include grow sites 53) and may employ a mechanism that registers with grooves 58a, 58b to accurately locate the grow tower and grow sites 53 relative to harvesting blades or other actuators. In the implementation shown, grow towers 50 are oriented such that the faces 101 with grow sites 53 face horizontally. In embodiments of the disclosure, harvester machine 2302 includes a first set of rotating blades that are oriented near a first face 101 of a grow tower 50 and a second set of rotating blades on an opposing face 101 of the grow tower 50. As the grow tower 50 is fed through the harvester machine 2302, crops extending from the grow sites 53 are cut or otherwise removed, where they fall into a bin placed under harvester machine 2302 by bin conveyor 2304. Harvester machine 2302 may include a grouping mechanism, as discussed in more detail below, to group the crops at a grow site 53 in order to facilitate the harvesting process. Bin conveyor 2304 may be a u-shaped conveyor that transports empty bins the harvester station 34 and filled bins from harvester station 32. In embodiments of the disclosure, a bin can be sized to carry at least one load of crop harvested from a single grow tower 50. In such an implementation, a new bin is moved in place for each grow tower that is harvested. Other implementations are possible. For example, the use of bins may be omitted. In embodiments of the disclosure, harvested crop falls directly onto a takeaway conveyor that conveys the crop to other stations for further processing.

FIG. 23B is a side elevation view of an example harvester machine 2302. Circular blades 2306 extending from a rotary drive system 2308 are disposed on opposite sides of a channel defined for a grow tower 50 and are operative to harvest plants on opposing faces 101 of grow towers 50. In embodiments of the disclosure, circular blades 2306 are each 6-7 inches in diameter and overlap slightly as shown in FIG. 23E. In embodiments of the disclosure, the spacing between the upper and lower circular blades is approximately 1/16^{th} of an inch. In embodiments of the disclosure, rotary drive system 2308 is mounted to a linear drive system 2310 to move the circular blades 2306 closer to and farther away from the opposing faces 101 of the grow towers 50 to optimize cut height for different types of plants. In embodiments of the disclosure, each rotary drive system 2308 has an upper circular blade and a lower circular blade (and associated motors) that intersect at the central axis of the grow sites of the grow towers 50. As FIG. 23B illustrates, harvester machine 2302 may also include a gathering chute 2330 that collects harvested crops cut by blades 2306 as it falls and guides it into bins located under the machine 2302. Harvester machine 2302 may also include an infeed mechanism that feeds grow towers through the machine 2302 at a constant rate. In embodiments of the disclosure, the infeed (and outfeed) mechanism includes drive wheel and motor assemblies 2312 located at opposite ends of harvester machine 2302. Each drive wheel and motor assembly 2312 may include a friction drive roller on the bottom and a pneumatically actuated alignment wheel on the top to drive or convey a grow tower 50 through a channel defined within the harvester 2302. Other implementations for feeding towers 50 into transplanter station 36 are possible. For example, in other implementations, the groove region 58 of a grow tower 50 may include a row of teeth extending along the length of the tower. In such an implementation, a friction drive roller can be replaced by a toothed wheel that positively engages the teeth in grove region 58. Such an implementation would allow the infeed and outfeed mechanisms to track the position of the grow tower as it moves through the harvester 2302.

As FIG. 23C illustrates, harvester 2302 may also include one or more grouping mechanisms operative to group the crops prior to harvesting by blades 2306. As shown in FIG. 4A, crops (such as leafy greens) may grow beyond the lateral face 101 and extend around to the upper and lower faces of the grow towers 50 (i.e., the faces that include grooves 58a, 58b). As discussed below, harvester 2302 may include a two-stage grouping mechanism. A first-stage or lead-in grouping mechanism removes crop from the upper and lower faces of grow tower 50, while a second-stage or internal grouping mechanism groups the crop for harvesting by blades 2306. The purpose of the lead-in grouping mechanism is to maximize the amount of plant matter that enters the internal grouping mechanism for eventual harvesting.

As FIGS. 23C and 23D show, in embodiments of the disclosure, the first-stage grouping mechanism includes an upper lead-in grouper 2314a and a lower lead-in grouper 2314b. Each of the lead-in groupers 2314a, 2314b include two angled faces 2316 that meet at a leading edge 2315. In the implementation shown, leading edges 2315 are disposed over the central axis of a grow tower 50 (or the channel in which the grow tower travels) when feeding through the harvester 2302. In the implementation shown, lead-in groupers 2314a,b also include faces 2317 adjacent to faces 2316. Faces 2317 generally run parallel to the direction of travel of the grow tower 50 and extend to the edge of the internal groupers 2330a,b as discussed in more detail below. In embodiments of the disclosure, the distance between faces 2317 of an internal grouper is substantially the same as the width of a grow tower 50. In the implementation shown, the leading edge 2315 is also angled. The lead-in groupers 2314a,b are configured, as a grow tower feeds through harvester 2302, to force plants extending over the upper and lower faces of the grow tower 50 away from these faces and away from the plane of the faces, thereby grouping them for operation by the internal grouping mechanisms discussed below. Bottom lead-in grouper 2314 may also include a ramped surface 2319 to ramp the plants up (which may be sagging downward from gravitational forces) toward the internal grouping mechanism.

The second-stage or internal grouping mechanism includes two pairs of grouping surfaces, where each pair operates on opposing sides of a grow tower 50 as it feeds through harvester 2302. FIG. 23E is a sectional view of the feed path of a grow tower. As FIG. 23E illustrates, the internal grouping mechanism includes an upper grouping member 2330a and a lower grouping member 2330b for each opposing lateral side of grow tower 50. Each of the grouping members 2330a,b have a grouping surface 2318. FIG. 23F is a perspective view of grouping member 2330b. Referring to grouping member 2330b, at the end 2336 of grouping surface 2318 that abuts against face 2317 of lead-in grouper 2314b, the grouping surface is substantially parallel to face 2317. In other words, grouping surface 2318 begins at an orientation that is substantially perpendicular to the top face of the grow tower 50 and substantially contiguous with face 2317. As FIGS. 23E and 23F illustrate, the grouping surface 2318 gradually transitions along its length and ends with its surface orientation parallel to the top face of the grow tower 50 (and perpendicular to its original orientation). In embodiments of the disclosure, the transition and the profile created for surface 2318 can generally correspond to a line that rotates about its midpoint from a parallel orientation at the first and to a perpendicular orientation at the second end. Grouping member 2330a (and its grouping surface 2318) substantially mirrors that of grouping member 2330b, as shown in FIG. 23E. As a grow tower 50 feeds through harvester 2302, the grouping members 2330a, 2330b cause crops growing from sites 53 of face 101 to converge toward the center of the face 101 of grow tower 50. Rotating blades 2306 harvest the plants as the grow tower feeds through, causing the harvested crop to fall into a bin.

In embodiments of the disclosure, each of grouping members 2330a,b are machined from stainless steel and include an internal cavity. In some implementations, grouping surface 2318 may include holes 2334 through which air travels. In embodiments of the disclosure, a compressed air system supplies pressured air to the internal cavities of grouping members 2330a,b to create air flow from grouping surfaces 2318 to prevent plants from sticking. Although not shown, the holes and compressed air system can be configured to group plants as well.

In embodiments of the disclosure, a drive mechanism (e.g., drive wheel and motor assembly 2312) may be used to move grow tower 50 along one or more conveyors (e.g., 1420, 1504, 2102, 2104, 2106, 2108, 2110, or 2112) or in one or more tower processing tools (e.g., harvester 32, washer 34, or transplanter 36). The drive mechanism may detect the presence of an approaching grow tower 50 using a sensor (e.g., limit switch, optical sensor, light beam-break sensor). In embodiments of the disclosure, the signal from an optical sensor may be used to engage the drive mechanism to drive the motion of the grow tower 50. For example, referring to FIG. 23C, the friction drive roller (2313a) may contact groove 58a in the grow tower 50 and the pneumatically actuated alignment wheel on the top (2313b) may be moved into contact with groove 58b in the grow tower 50. The motor coupled to the friction drive roller 2313a causes motion of the grow tower 50 by applying a friction-based force on the grow tower 50 in groove 58a. The friction-based force may be controlled by controlling the normal force between the grow tower 50 and the friction drive roller 2313a. In embodiments of the disclosure, the normal force is controlled based on the force applied to the groove 58b in the grow tower 50 by the pneumatically actuated alignment wheel 2313b.

In some embodiments, the friction drive roller 2313a may slip relative to the surface of groove 58a. The slippage of the friction drive roller 2313a may lead to loss of information regarding grow tower 50 indexed position along a converyor or inside of a tower processing tool. In some embodiments, the slippage of grow tower 50 (when driven by a drive mechanism) may be detected by comparing the expected motion of grow tower 50 (e.g., based on the number of turns of friction drive roller 2313a) to the actual distance traved by the grow tower 50. The distance traveled by grow tower 50 may be determined by detecting the motion of a grow tower edge between two optical sensors located a known distance apart from each other along the direction of motion for the grow tower (e.g., along a conveyor).

In some embodiments, the slippage of grow tower 50 may be detected by comparing the number of turns of friction drive roller 2313a when in contact with a grow tower to the number of turns of alignment wheel 2313b in contact with the same grow tower. If neither the friction drive roller 2313a nor the alignment wheel 2313b slip relative to grow tower 50, the number of turns of friction drive roller 2313a and the number of turns of alignment wheel 2313b may be related to the ratio of the friction drive roller 2313a and the alignment wheel 2313b radius, diameter, or circumference. In some embodiments, the the number of turns of friction drive roller 2313a and the number of turns of alignment wheel 2313b may be related to the ratio of the friction drive roller 2313a circumference and the alignment wheel 2313b circumference after taking into account the deformation of the friction drive roller 2313a or the alignment wheel 2313b caused by the contact force between the respective roller or wheel and grow tower 50.

In some embodiments, the number of turns of friction drive roller 2313a may be determined based on the signal sent to the motor coupled to the friction drive roller. In some embodiments, the number of turns of the alignment wheel 2313b may be determined by placing a magnetic mark on a component that moves in response to motion of the alignment wheel 2313b (e.g., magnetic mark embedded in the alignment wheel 2313b, magnetic mark on an axle of the alignment wheel 2313b) and using an inductive sensor to count the number of turns of the alignment wheel 2313b. In some embodiments, the number of turns of the alignment wheel 2313b may be determined using an optical encoder coupled to the alignment wheel 2313b or a component coupled to the alignment wheel 2313b.

In some embodiments, debris (e.g., plant matter) or water may be present in groove 58a or 58b of grow tower 50. The debris or water may contribute to slippage of grow tower 50 in the drive mechanism. In some embodiments, slippage may be mitigated by directing a flow of pressurized gas to disperse water or debris from the region to be contacted in the drive mechanism (e.g., directing pressurized gas towards a region in groove 58a before friction drive roller 2313a contacts the region). In some embodiments, slippage may be mitigated by removing any debris from the region to be contacted in the drive mechanism. For example, a brush may be used to remove debris from groove 58a before friction drive roller 2313a.

In some embodiments, slippage of grow tower 50 when driven by the drive mechanism may be mitigated by adjusting the friction between the friction drive roller 2313a or the contact area on grow tower 50. In some embodiments, the friction of the friction drive roller may be adjusted by changing the roller material or changing the durometer of the roller material. In some embodiments, the friction of the area on the grow tower contacted by the friction drive roller 2313a may be adjusted by changing the surface texture of the grow tower in that area (e.g., roughening the surface (e.g., via mechanical or chemical abrasion)). In some embodiments, the contact area of the friction drive roller 2313a may be a patterned tread. In some embodiments, the tread pattern may permit debris or water to move into a tread gap region to enhance frictional contact between the friction drive roller 2313a and a contact area on grow tower 50.

In some embodiments, detection of grow tower 50 slippage is used to trigger one or more actions. In some embodiments, detection of grow tower 50 slippage is used as an indication that a mechanical jam has occurred, or a user of the conveyor or tower processing tool may be informed (e.g., to take corrective action). In some embodiments, detection of grow tower 50 slippage is used to turn off the motor coupled to the friction drive roller 2313a to prevent wear of the friction drive roller 2313a or the area contacted by the friction drive roller 2313a on the grow tower 50. In some embodiments, detection of grow tower 50 slippage is tracked in a database to identify grow towers that are prone to slippage.

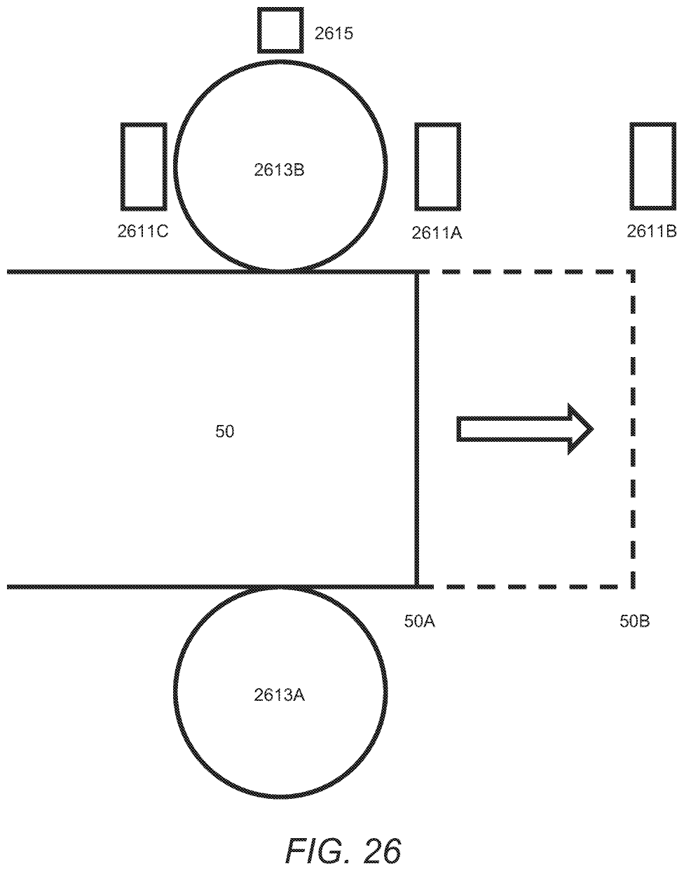

FIG. 26 shows an exemplary schematic representation of the drive mechanism. The drive mechanism moves a grow tower 50 from a first position 50A (solid box) to a second position 50B (dashed box)—in the direction of the arrow. Grow tower sensors 2611A and 2611B detect the presence of grow tower 50 at the first position 50A and second position 50B, respectively. Sensors 2611A, 2611B, and 2611C may be optical sensors to detect the edge of the grow tower 50. Sensor 2615 detects the rotation of the alignment wheel 2613B. The rotation of the friction drive roller 2613A may be determined based on the drive signal sent to the motor (not shown) coupled to the friction drive roller.

In some embodiments, the number of revolutions of the friction drive roller 2613A may be compared to the number of revolutions of the alignment wheel 2613B to detect slippage. In some embodiments, some amount of slippage between the grow tower 50 and the friction drive roller 2613A may be permitted before an action is taken. In some embodiments, if the diameters of the friction drive roller 2613A and the alignment wheel 2613B are the same, a slippage detection signal may be triggered if the number of revolutions of the friction drive roller 2613A and the number of revolutions of the alignment wheel 2613B differ by more than a certain threshold percentage (e.g., 1%, 5%, 10%, or more) or if the number of revolutions of the friction drive roller 2613A and the number of revolutions of the alignment wheel 2613B differ by more than a certain threshold amount (e.g., ¼ turn, ½ turn, 1 turn, or more of the friction drive roller 2613A). If the radius/diameter/circumference of the friction drive roller 2613A and the alignment wheel 2613B are different, a slippage detection signal may be triggered by comparing the radius/diameter/circumference-scaled number of revolutions. For example, if the friction drive roller 2613A has double the diameter of the alignment wheel 2613B, the number of turns of the friction drive roller 2613A may be compared to double the number of turns of the alignment wheel 2613B.

In some embodiments, slippage may be detected if the distance traveled by a point on the circumference of the friction drive roller 2613A contacting the grow tower 50 (based on the number of turns of the friction drive roller 2613A) differs from the measured distance traveled by the grow tower 50. The distance traveled by a point on the circumference of the friction drive roller 2613A may represent a desired distance of travel of the grow tower 50 that is commanded by an operator of the drive mechanism. For example, assuming no slippage, if 5 turns of the friction drive roller 2613A corresponds to motion of the grow tower 50 from the position of grow tower sensor 2611A (with grow tower 50 edge at 50A) to the position of grow tower sensor 2611B (with grow tower 50 edge at 50B), then slippage may be inferred if the friction drive roller 2613A turns more than 5 turns to move the grow tower 50 from the position of grow tower sensor 2611A to the position of grow tower sensor 2611B. In some embodiments, a slippage detection signal may be triggered if the friction drive roller 2613A turns more than a certain threshold percentage (e.g., 1%, 5%, 10%, or more) above the expected 5 turns or if the friction drive roller 2613A turns more than a certain threshold amount (e.g., ¼ turn, ½ turn, 1 turn, or more) above the expected 5 turns.

In some embodiments, a signal indicating the presence of the grow tower 50 based on a signal from sensor 2611C may trigger the engagement and activation of the drive mechanism (e.g., engagement and activation of the friction drive roller 2613A and the alignment wheel 2613B) to move the grow tower 50. In some embodiments, the friction drive roller 2613A and the alignment wheel 2613B may move vertically for engagement (e.g., to bring them into contact with one or more grow tower surfaces). In some embodiments, the signal from sensor 2611C may trigger the motor coupled to the friction drive roller 2613A to start turning the friction drive roller 2613A. In some embodiments, once signal from sensor 2611A indicates that a grow tower 50 is present in the drive mechanism, the rotations of the friction drive roller 2613A and the alignment wheel 2613B may be compared to generate a slippage detection signal. In some embodiments, the motion of the grow tower 50 from position 50A (based on a signal from sensor 2611A) to position 50B (based on signal from sensor 2611B) may be compared to the rotations of the friction drive roller 2613A to generate a slippage detection signal. In some embodiments, the slippage detection signal may trigger another action. In some embodiments, the triggered action may be one or more of: (1) stopping the drive mechanism, (2) disengaging the drive mechanism (e.g., bringing friction drive roller 2613A or alignment wheel 2613B out of contact with the grow tower 50), (3) alerting a user of the conveyor or tower processing tool, or (4) recording an ID associated with the grow tower 50 in the drive mechanism and information related to the detected slippage (e.g., slippage as a percentage, distance, or number of turns).

In sum, slippage may be detected in a number of ways. In general, a conveyance system of embodiments of the disclosure compares representations of desired grow tower 50 motion or position in the direction of conveyance with measured grow tower 50 motion or position. For example, desired grow tower 50 motion or position may be represented by: a desired distance of travel (e.g., commanded by an operator), which may, for example, be a desired distance to be traveled by a point on the circumference of the friction drive roller 2613A, or a desired distance of travel of an edge of the grow tower 50; or a desired speed of the grow tower 50, such as a desired speed for an edge of the grow tower 50 or based on a desired rate of rotation of the friction drive roller 2613A.

The measured grow tower 50 motion or position may be represented by: a measured distance of travel, which may, for example, be a measured distance traveled by a point on the circumference of alignment wheel 2613B, or a measured distance of travel of an edge of the grow tower 50; or a measured speed of the grow tower 50, such as that measured for an edge of the grow tower 50 or based on the measured rate of rotation of the alignment wheel 2613B.

Other implementations are possible. For example, the harvester 2302 may be configured such that faces 101 of grow tower 50 are oriented vertically when positioned in the harvester. In other implementations, the harvester 2302 could be configured such that grow towers 50 are oriented vertically during harvesting operations. In addition, while the embodiments described above involve a stationary harvester mechanism with moving grow towers, other embodiments may involve a moving harvester mechanism and stationary grow towers. In such an implementation, the grouping mechanisms and harvesting blades may move relative to the stationary tower faces. Still further, while the systems described above involve grow towers with grow sites at opposing lateral faces, implementations of the harvester can be configured to operate with grow towers or other grow structures having grow sites on only a single face.

The foregoing discloses a harvesting system where grow towers 50 feed through the harvester 2302 in a single direction into an entry point and out of an exit point. Other implementations are possible. For example, the infeed and outfeed mechanisms can be controlled to drive a grow tower 50 in a first direction for harvesting, as discussed above. A controller can then cause the harvesting blades 2306 to retract and cause the infeed and outfeed mechanisms 2312 to drive the grow tower 50 in the reverse direction back through the harvester 2302. In such an implementation, a second gathering mechanism can be disposed at the exit point of harvester 2302 opposite the entry point to gather and/or protect remaining plant stalks and other plant matter as a harvested grow tower 50 is conveyed back through harvester station 2302.

FIGS. 27A and 27B illustrate a tower drive unit (“TDU”) 2700 in closed and open positions according to embodiments of the disclosure. A TDU frame 2702 supports a drive element 2704 and an alignment element 2706. The drive element 2704 may be driven by one or more motors to convey a grow tower 50 through the TDU 2700. According to embodiments of the disclosure, any of conveyors 1420, 1504, 2102, 2104, 2106, 2108, 2110, or 2112 may be implemented using a TDU 2700, or using a belt conveyor, a roller conveyor, or another conveyance mechanism.

As shown, the drive element 2704 and the alignment element 2706 may each comprise two or more wheels. As shown, two alignment wheels 2706 are rotatably mounted on to a mount plate 2707. In general, the alignment element 2706 may take the form of, for example, one or more elements that rotate, or that are static but that allow a grow tower to slide with low friction between the drive element 2704 and the alignment element 2706. For example, the alignment element may comprise one or more rollers, one or more wheels, a linear bearing element (e.g., a plain bearing element) designed to allow the grow tower 50 to slide against the alignment element 2706, a belt, a tread, one or more gears designed to mesh with complementary teeth on the opposing surface of the grow tower 50, or a fixed material that has a coefficient of friction against the plant support structure less than a coefficient of friction of the drive element against the plant support structure. According to embodiments of the disclosure, the alignment element 2706 may comprise a plastic material, for example a thermoplastic such as Delrin®.

The drive element may, for example, comprise one or more rollers, one or more wheels, a belt, a tread, a linear actuator, or one or more gears designed to mesh with complementary teeth on the opposing surface of the grow tower 50. The linear actuator (e.g., a solenoid, a pneumatic or hydraulic piston) may, for example, pull or push the grow tower 50. According to embodiments of the disclosure, the linear actuator may grab the tower 50 by its hook 52 and pull it in the direction of travel. The drive element 2704 may be coated with or fabricated from a material with a relatively high coefficient of friction, such as polyurethane with a kinetic coefficient of friction greater than 1.

The TDU frame may include an upper sub-frame 2708 that hingeably attaches to the rest of the frame 2702 (the rest of the frame referred to herein as the “base”) via a hinge element 2710. The hinge element 2710 may comprise a pin or rod integrally coupled with the upper sub-frame 2708, where the ends of the pin or rod are rotatably fitted into holes in members of the base of the frame 2702.

An actuator 2712, such as a pneumatic or hydraulic piston, is coupled to the base and to the upper sub-frame 2708. As shown in FIG. 27A, the TDU 2700 is in a closed position with the actuator 2712 in an extended position. As shown in FIG. 27B, the TDU 2700 is in an open position with the actuator 2712 in a contracted position. The position of the actuator 2712 may be controlled by a controller.

At different points during processing, a grow tower 50 is laid down, e.g., by a robot arm, in a horizontal position and conveyed, according to embodiments of the disclosure. According to some conveyance approaches, the alignment wheels and the drive wheels bear a fixed relationship to each other. In those approaches, the tower 50 is inserted laterally between the upper and lower wheels along the axis of conveyance. The fixed rollers impart more force on the leading and trailing edges of the tower conveyed through them than on the rest of the tower body. These edge forces lead to damage of the edges after a tower has been inserted and conveyed multiple times.

The adjustable-access tower drive unit according to embodiments of the disclosure, such as that shown in FIGS. 27A-C, prevents the edge damage problem encountered with the fixed-access TDU discussed elsewhere herein. For example, a robot arm may insert a grow tower along the axis of conveyance with the alignment element 2706 in a raised, open position so that the alignment element 2706 is not imparting a force on the leading edge of the grow tower. The controller may actuate the drive element 2704 to convey the grow tower. After the leading edge of the grow tower has passed the position of the alignment element 2706, the controller may cause actuator 2712 to lower the alignment element 2706 onto the body of the grow tower, thereby avoiding contact between the alignment element 2706 and the leading edge of the grow tower.

Instead of insertion of the grow tower along the axis of conveyance, the adjustable-access TDU 2700 enables more freedom with respect to the angle of insertion of a grow tower into the TDU. For example, with the alignment element 2706 in the open position, the controller may instruct a robot arm to insert the grow tower in a direction normal to the face of the TDU. The tower may be laid down so that the leading edge would not bear the force of the alignment element 2706 when the TDU is in the closed position, thereby preventing tower edge damage. After the grow tower is laid down on the drive element 2704, the controller may cause extension of the actuator 2712 to move the alignment element 2706 to rest on top of the laid-down tower.

According to embodiments of the disclosure, the controller may cause the actuator 2712 not just to enable the alignment element 2706 to rest on top of the laid-down tower, but to apply a force to the alignment element 2706 to force the grow tower against the drive element 2704 to increase friction.

In the embodiment shown in FIGS. 27A and 27B, the TDU face is a plane defined by the circular area of the drive wheels 2704, and the direction normal to the face would correspond to the direction of the axles 2714 of the drive wheels 2704. According to embodiments of the disclosure, the tower 50 is be inserted so that the longitudinal grooves (such as 58a and 58b) of the tower 50 align with the drive element 2704 and the alignment element 2706 so that an outer, circumferential portion of those elements fit into the grooves.

FIG. 27C is a side view of the TDU 2700 in a closed position in which the alignment element 2706 rests on a laid-down grow tower 50. In this example, plants grow out laterally from the sides of the tower 50. The TDU 2700 in this embodiment is configured (including sizing) so that portions of the TDU do not contact the plants. The region of plant growth is represented by a keep-out volume 2720. A TDU of this sizing may be used to introduce a grow tower 50 that bears plants into a harvester station 32. As example, for plants such as kale, the keep-out volume may have a hanging width “W” of 225 mm and a hanging height “H” of 350 mm.

According to embodiments of the disclosure, the mount plate 2707 includes a pivot 2709 about which the mount plate 2707 can rotate. The pivot 2709 enables the alignment wheels 2706 to self-adjust so that they are in contact with the tower 50 body even if tower is not disposed perfectly horizontally (e.g., upon insertion into the TDU 2700) or the tower 50 body varies in thickness.

According to embodiments of the disclosure, by offsetting the pivot 2709 from the horizontal center of gravity of the mount plate 2707 (e.g, more to one side than the other), gravity will pull down one alignment wheel 2706 more than the other, resulting in an angular bias of the mount plate 2707. For example, the alignment wheels 2706 can be biased to create a greater nominal distance between a corresponding drive wheel 2704 and an alignment wheel 2706 closest to the leading edge of the tower 50 being received by the TDU 2700. This would reduce the chance of damaging the leading edge of the tower 50 upon reception.

FIG. 27D illustrates a TDU 2700 with some variations to the TDU 2700 of FIGS. 27A, B, and C. FIG. 27D illustrates a support 2754, here shown in an inverted “T” form. Alignment wheels 2706 are rotatably coupled to the support 2754. The support 2754 is itself rotatably coupled to a mount plate 2707a via a pivot 2709a. The mount plate 2707a includes limit stops 2750. A rod or similar member(s) 2752 projects from the pivot 2709, e.g. radially from opposite sides of the pivot 2709a. The interaction of the stops 2750 and the member 2752 limits rotational travel about the pivot 2709a of the support 2754. The more space between the stops 2750 and the corresponding end projections of the member 2752, the greater the allowable rotational travel. One advantage of this arrangement is that it prevents the alignment wheels 2706 from rotating about the pivot 2709 an undesirable amount, e.g., 90 degrees.

According to embodiments of the disclosure, the TDU 2700 may employ slippage detection as described with respect to other embodiments of the disclosure (e.g., with respect to FIG. 26). Based on detected slippage, the controller may cause the TDU 2700 to take one or more actions such as those described elsewhere herein, such as, but not limited to: (1) stopping conveyance motion of the drive element 2704 (e.g., stopping rotation of the drive wheels 2704), (2) disengaging the TDU 2700 (e.g., bringing drive element 2704 or alignment element 2706 out of contact with the grow tower 50), (3) alerting a user of the TDU 2700, or (4) recording an ID associated with the grow tower 50 in TDU 2700 and information related to the detected slippage (e.g., slippage as a percentage, distance, or number of turns).

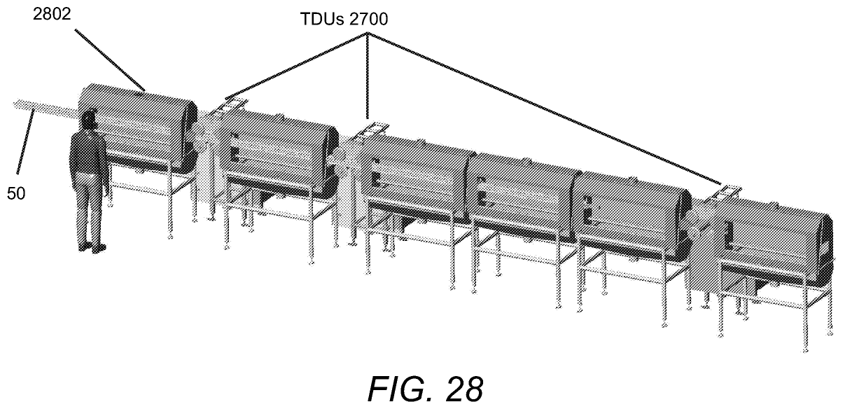

After harvesting, the tower 50 no longer has plants extending from its sides. Thus, a TDU of smaller sizing that does not accommodate a keep-out volume may be employed to convey a tower at the outfeed of the harvester station 32, to introduce the harvested tower to washing station 34, to remove the tower from the washing station 34, and to introduce the tower to the transplanter station 36. As an example, FIG. 28 illustrates a tower 50 being conveyed by the TDUs 2700 through multiple tower cleaning modules 2802 of the washing station 34. At this stage of the conveyance, the tower 50 rests on two TDUs 2700. Note that the TDUs of embodiments of the disclosure are standalone. They do not need to be fixedly attached on to the harvester or washing stations or any other processing station, but rather can be moved around, if desired.

After transplantation at transplanter station 36 of seedlings into a tower, the seedlings occupy only a small region outside the tower body, thus requiring a much smaller keep-out volume than a TDU conveying a tower with mature plants into harvester station 32. Accordingly, a TDU of smaller sizing than that used to convey towers to the harvester station 32 may be employed. Grow tower sensors in a tower drive unit 2700, similar to sensors 2611A and 2611B, may detect the presence of grow tower 50 as it is approaches or is conveyed through the TDU 2700. In particular, the sensors may be optical sensors to detect the leading and trailing edges of the grow tower 50 or the approach of the tower body in a direction normal to the face of the drive element 2704. In embodiments, sensors may be placed anywhere near the TDU 2700 along the expected path that a grow tower 50 would follow to be introduced into the TDU 2700.

In embodiments, in response to receiving a signal from one or more sensors indicating the approach of the grow tower 50, the controller may trigger the actuator 2712 to open the TDU 2700 by moving the alignment element 2706 away from the drive element 2704, if the TDU 2700 is not already in an open position from a previous conveyance operation. Upon detection by one or more sensors that the grow tower 50 has been brought to rest on the drive element 2704, the controller may move the TDU 2700 into a closed position so that the alignment element 2706 is brought in contact with the uppermost surface of grow tower 50 (i.e., the tower side surface facing upward while the grow tower 50 is in a horizontal position), thereby engaging the alignment element 2706 and the drive element 2704 with the grow tower 50. After the grow tower is engaged, the controller may activate the motor or other actuator coupled to the drive element 2704 to turn the drive element 2704 and convey the grow tower 50 through the TDU 2700.

One advantage of the TDU 2700 of embodiments of the disclosure is that only a few elements (e.g., the drive element 2704) of the TDU 2700 come into contact with plant material. Many of the elements, e.g. sub-frame 2708, may be formed of smooth, tubular pieces from which plant material and water slips off easily. The TDU 2700 also minimizes the number of horizontal surfaces on which plant material and water may gather. According to embodiments of the disclosure, the TDU 2700 may be a “clean in place” style system in which nozzles of cleaning fluid, water, or air (or a combination thereof) are pointed at the wheels and shafts (the only plant contact surfaces) so they can be automatically cleaned.

One or more of the controllers (otherwise referred to herein as one or more control systems) discussed above, such as the one or more controllers for central processing system 30 or individual stations thereof, may be implemented as follows. FIG. 25 illustrates an example of a computer system 800 that may be used to execute program code stored in a non-transitory computer readable medium (e.g., memory) in accordance with embodiments of the disclosure. The computer system includes an input/output subsystem 802, which may be used to interface with human users or other computer systems depending upon the application. The I/O subsystem 802 may include, e.g., a keyboard, mouse, graphical user interface, touchscreen, or other interfaces for input, and, e.g., an LED or other flat screen display, or other interfaces for output, including application program interfaces (APIs). Other elements of embodiments of the disclosure, such as the controller, may be implemented with a computer system like that of computer system 800.

Program code may be stored in non-transitory media such as persistent storage in secondary memory 810 or main memory 808 or both. Main memory 808 may include volatile memory such as random-access memory (RAM) or non-volatile memory such as read only memory (ROM), as well as different levels of cache memory for faster access to instructions and data. Secondary memory may include persistent storage such as solid-state drives, hard disk drives or optical disks. One or more processors 804 reads program code from one or more non-transitory media and executes the code to enable the computer system to accomplish the methods performed by the embodiments herein. Those skilled in the art will understand that the processor(s) may ingest source code, and interpret or compile the source code into machine code that is understandable at the hardware gate level of the processor(s) 804. The processor(s) 804 may include graphics processing units (GPUs) for handling computationally intensive tasks.

The processor(s) 804 may communicate with external networks via one or more communications interfaces, such as a network interface card, WiFi transceiver, etc. A bus 805 communicatively couples the I/O subsystem 802, the processor(s) 804, peripheral devices 806, communications interfaces, memory 808, and persistent storage 810. Embodiments of the disclosure are not limited to this representative architecture. Alternative embodiments may employ different arrangements and types of components, e.g., separate buses for input-output components and memory subsystems.

Those skilled in the art will understand that some or all of the elements of embodiments of the disclosure, and their accompanying operations, may be implemented wholly or partially by one or more computer systems including one or more processors and one or more memory systems like those of computer system 800. In particular, the elements of automated systems or devices described herein may be computer-implemented. Some elements and functionality may be implemented locally and others may be implemented in a distributed fashion over a network through different servers, e.g., in client-server fashion, for example.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive “or” in the manner of “and/or.”

Those skilled in the art will recognize that, in some embodiments, some of the operations described herein may be performed by human implementation, or through a combination of automated and manual means. When an operation is not fully automated, appropriate components of embodiments of the disclosure may, for example, receive the results of human performance of the operations rather than generate results through its own operational capabilities.

All references cited herein, including, without limitation, articles, publications, patents, patent publications, and patent applications, are incorporated by reference in their entireties for all purposes, except that any portion of any such reference is not incorporated by reference herein if it: (1) is inconsistent with embodiments of the disclosure expressly described herein; (2) limits the scope of any embodiments described herein; or (3) limits the scope of any terms of any claims recited herein. Mention of any reference, article, publication, patent, patent publication, or patent application cited herein is not, and should not be taken as an acknowledgment or any form of suggestion that it constitutes valid prior art or forms part of the common general knowledge in any country in the world, or that it discloses essential matter.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the claims.

In the claims below, a claim n reciting “any one of the preceding claims starting with claim x,” shall refer to any one of the claims starting with claim x and ending with the immediately preceding claim (claim n-1). For example, claim 35 reciting “The system of any one of the preceding claims starting with claim 28” refers to the system of any one of claims 28-34.

### SELECTED EMBODIMENTS OF THE DISCLOSURE

1. A harvester, comprising
one or more harvesting mechanisms;
an infeed mechanism configured to convey a grow structure along a channel to the one or more harvesting mechanisms, wherein the grow structure has a first face including one or more grow sites thereon and second and third faces extending from opposite sides of the first face;
a grouping assembly comprising first and second grouping members disposed on opposing sides of the channel, wherein the first grouping and second grouping members each comprise a grouping surface defined therein, wherein the grouping surface is configured to force crop matter extending from a grow site to converge as the grow site passes along the first and second grouping members;
   wherein the grouping surface has a first end and a second end, wherein the grouping surface at the first end extends substantially parallel to the first face, wherein the grouping surface at the second end extends substantially perpendicular to the first face, wherein the grouping surface transitions from the first end to the second end.

2. The harvester of embodiment 1 further comprising a lead-in grouping mechanism comprising a first ramped surface member disposed over the second face of the grow structure when located in the channel, and a second ramped surface member disposed over the third face of the grow structure when located in the channel, wherein the first ramped surface member terminates at the first end of the grouping surface of the first grouping member and wherein the second ramped surface member terminates at the first end of the grouping surface of the second grouping member.

3. The harvester of embodiment 1 wherein each grouping surface includes a plurality of air holes defined therein, and wherein the harvester further comprises a compressed air system to deliver air to each grouping member.

4. A harvester for processing a grow tower, wherein the grow tower includes grow sites on opposing faces thereof, the harvester comprising:
an infeed mechanism operative to convey the grow tower along a channel, wherein the opposing faces of the grow tower are oriented horizontally;
an upper lead-in feature disposed over the channel, wherein the upper lead-in feature comprises first and second ramped surfaces meeting at a leading edge, wherein the leading edge is disposed substantially over a central axis of the channel;
a lower lead-in feature disposed under the channel, wherein the upper lead-in feature comprises first and second ramped surfaces meeting at a leading edge, wherein the leading edge is disposed substantially under the central axis of the channel;
a first side grouping mechanism comprising first and second grouping members disposed on opposing upper and lower sides of the channel, wherein the first grouping and second grouping members each comprise a grouping surface defined therein, wherein the grouping surface is configured to force crop matter extending from a grow site to converge as the grow site passes along the first and second grouping members; wherein a first side of the upper lead-in feature terminates at a first end of the grouping surface of the first grouping member and wherein a first side of the lower lead-in feature terminates at the first end of the grouping surface of the second grouping member;
a second side grouping mechanism disposed across the channel opposite the first side grouping member and comprising third and fourth grouping members disposed on opposing upper and lower sides of the channel, wherein the third and fourth grouping members each comprise a grouping surface defined therein, wherein the grouping surface is configured to force crop matter extending from a grow site to converge as the grow site passes along the third and fourth grouping members;
   wherein a second side of the upper lead-in feature terminates at a first end of the grouping surface of the third grouping member and wherein a second side of the lower lead-in feature terminates at the first end of the grouping surface of the fourth grouping member; and
a harvesting mechanism disposed along the channel adjacent to the first and second side grouping mechanisms.

5. The harvester of embodiment 4 wherein the grouping surface for each of the first, second, third and fourth grouping members has a first end and a second end, wherein the grouping surface at the first end extends substantially parallel to the first face, wherein the grouping surface at the second end extends substantially perpendicular to the first face, wherein the grouping surface transitions from the first end to the second end.

6. The harvester of embodiment 4 further comprising an outfeed mechanism disposed in the channel after the harvesting mechanism.

7. The harvester of embodiment 4 wherein the infeed mechanism comprises a pneumatic roller disposed on one side of the channel and a drive wheel disposed on an opposite side of the channel.

8. The harvester of embodiment 7 wherein the grow tower further comprises grooves extending along upper and lower faces thereof, and wherein the pneumatic roller and the drive wheel are configured to engage the respective grooves of the grow tower.

9. The harvester of embodiment 4 wherein the lower lead-in feature further comprises a ramped surface angled upwardly along the channel.

10. The harvester of embodiment 4 wherein the upper lead-in feature further comprises a third face contiguous with the first ramped surface and extending parallel to the channel, and a fourth face contiguous with the second ramped surface and extending parallel to the channel.

11. The harvester of embodiment 10 wherein the lower lead-in feature further comprises a third face contiguous with the first ramped surface and extending parallel to the channel, and a fourth face contiguous with the second ramped surface and extending parallel to the channel.

12. The harvester of embodiment 4 wherein each grouping surface includes a plurality of air holes defined therein, and wherein the harvester further comprises a compressed air system to deliver air to each grouping member.

13. The harvester of embodiment 4 wherein the harvesting mechanism comprises one or more rotating blades disposed on a first lateral side of the channel, and one or more rotating blades disposed on a second, opposing lateral side of the channel.

14. The harvester of embodiment 4 further comprising a chute disposed under the harvesting mechanism.

15. The harvester of any one of embodiments 1-3, wherein the infeed mechanism further comprises one or more sensors configured to detect motion of the grow structure along the channel, and the harvester further comprises a grow structure conveyance system operable to detect slippage of the grow structure based at least in part upon a signal from at least one of the one or more sensors.

16. The harvester of any one of embodiments 4-14, wherein the infeed mechanism further comprises one or more sensors configured to detect motion of the grow tower along the channel, and the harvester further comprises a grow tower conveyance system operable to detect slippage of the grow tower based at least in part upon a signal from at least one of the one or more sensors.

17. A system for controlling the conveyance of a grow tower along a channel, the system comprising:
a drive mechanism, comprising an actuator configured to move the grow tower along the channel;
a sensor configured to detect position or motion of the grow tower; one or more processors; and
a memory coupled to the one or more processors and storing instructions which, when executed by at least one of the one or more processors, cause performance of:
providing information to cause the actuator to move the grow tower by a target distance along the channel;
determining a first distance moved by the grow tower along the channel in response to the provided information, wherein the first distance is based at least in part upon a signal from the sensor; and
generating a slippage detection signal based at least in part upon comparing the target distance to the first distance.

18. The system of embodiment 17, wherein the slippage detection signal triggers an action.

19. The system of embodiment 18, wherein the action comprises alerting a user of the system.

20. The system of any one of embodiments 18 or 19, wherein the action comprises stopping the movement of the grow tower by the actuator.

21. The system of any one of embodiments 18-20, wherein the action comprises storing information related to the grow tower.

22. The system of any one of embodiments 18-21, wherein the actuator comprises a friction drive roller roller coupled to a motor.

23. The system of any one of embodiments 18-21, wherein the actuator is a linear actuator.

1. A method for operating one or more drive units in a controlled agricultural environment, the method comprising:
(a) for each of the one or more drive units, increasing a distance between an alignment element and a drive element;
(b) receiving a plant support structure that is oriented non-vertically so that the plant support structure rests on the drive element or the alignment element of each of the one or more drive units; and
(c) for each of the one or more drive units, decreasing the distance between the alignment element and the drive element so that the alignment element or the drive element rests on the plant support structure.

2. The method of claim 1 further comprising, for each of the one or more drive units, driving the drive element to convey the plant support structure.

3. The method of claim 1, wherein the plant support structure comprises a grow tower.

4. (canceled)

5. The method of claim 1, wherein decreasing the distance is performed in response to sensing the presence of the plant support structure in the drive unit.

6. (canceled)

7. (canceled)

8. The method of claim 1, further comprising generating a slippage detection signal based at least in part upon a comparison of a measured position or motion of the plant support structure with a desired position or motion of the plant support structure.

9. The method of claim 8, further comprising triggering an action based at least in part upon the slippage detection signal.

10. A drive unit in a controlled agricultural environment, the drive unit comprising:
(a) an alignment element;
(b) a drive element; and
(c) an actuator for adjusting a distance between the alignment element and the drive element,
wherein the actuator is operable to increase the distance to enable reception of a plant support structure, and to decrease the distance to cause the alignment element and the drive element to contact opposing sides of the plant support structure.

11. The drive unit of claim 10, further comprising a second actuator for driving the drive element to convey the plant support structure.

12. The drive unit of claim 10, wherein the plant support structure comprises a grow tower.

13. (canceled)

14. The drive unit of claim 10, wherein the actuator is operable to decrease the distance in response to one or more sensors sensing the presence of the plant support structure in the drive unit.

15. The drive unit of claim 10, wherein the actuator is operable to apply a force via the alignment element or the drive element to force the plant support structure against the drive element or the alignment element, respectively.

16. The drive unit of claim 10, wherein:
a. the alignment element comprises one or more rollers, one or more wheels, a linear bearing element, a belt, a tread, one or more gears, or a fixed material that has a coefficient of friction against the plant support structure less than a coefficient of friction of the drive element against the plant support structure; and
b. the drive element comprises one or more rollers, one or more wheels, a belt, a tread, a linear actuator, or one or more gears.

17. The drive unit of any one of the preceding claims starting with claim 10, further comprising:
a. one or more sensors;
b. one or more memories storing instructions; and
c. one or more processors, coupled to the one or more memories, that execute the instructions to cause performance of:
i. commanding the drive element to achieve a desired position or motion of the plant support structure;
ii. determining a measured position or motion of the plant support structure, wherein the measured position or motion is based at least in part upon a signal from the one or more sensors; and
iii. generating a slippage detection signal based at least in part upon comparing the measured position or motion with the desired position or motion.

18. A system for controlling the conveyance of a plant support structure, the system comprising:
a drive mechanism, comprising an actuator configured to move the plant support structure along a direction of conveyance;
one or more sensors configured to detect position or motion of the plant support structure;
one or more memories storing instructions; and
one or more processors, coupled to the one or more memories, that execute the instructions to cause performance of:
commanding the actuator to achieve a desired position or motion of the plant support structure along the direction of conveyance;
determining a measured position or motion of the plant support structure, wherein the measured position or motion is based at least in part upon a signal from the one or more sensors; and
generating a slippage detection signal based at least in part upon comparing the measured position or motion with the desired position or motion.

19. The system of claim 18, wherein the slippage detection signal triggers an action.

20. The system of claim 19, wherein the action comprises alerting a user of the system.

21. The system of claim 19, wherein the action comprises stopping the movement of the plant support structure by the actuator.

22. The system of claim 19, wherein the action comprises storing information related to the plant support structure.

23. The system of claim 18, wherein the actuator comprises a friction drive roller roller coupled to a motor.

24. The system of claim 18, wherein the actuator is a linear actuator.

25. (canceled)

26. (canceled)
